(19) United States
(12) Patent Application Publication
(10) Pub. No.: US 2017/0075327 A1
(43) Pub. Date: Mar. 16, 2017

(54) SENSOR CONTROL APPARATUS, SENSOR SYSTEM AND BRIDGE MONITORING SYSTEM

(71) Applicant: Renesas Electronics Corporation, Tokyo (JP)

(72) Inventor: Norio OKADA, Tokyo (JP)

(21) Appl. No.: 15/208,337

(22) Filed: Jul. 12, 2016

(30) Foreign Application Priority Data
Sep. 11, 2015 (JP) 2015-179073

(51) Int. Cl. G05B 19/042

(52) U.S. Cl. CPC G05B 19/042; G05B 2219/24001; G05B 2219/24019

(57) ABSTRACT

To use a sensor element for a plurality of purposes. A sensor control apparatus connected to at least one sensor element, includes a storage unit configured to store a plurality of programs, in each of which a series of processes including making a predetermined setting for the sensor element, processing a measurement result based on that setting, and transmitting the processing result to an external apparatus is implemented, and execution definition information in which mutually different execution time periods are defined for the plurality of programs, and a control unit configured to receive predetermined maintenance information from the external apparatus and perform a process based on that maintenance information while a first program is being executed among the plurality of user programs based on the execution definition information.

### CROSS-REFERENCE TO RELATED APPLICATIONS

This application is based upon and claims the benefit of priority from Japanese patent application No. 2015-179073, filed on Sep. 11, 2015, the disclosure of which is incorporated herein in its entirety by reference.

### BACKGROUND

The present invention relates to a sensor control apparatus, a sensor system, and a bridge monitoring system. For example, the present invention relates to a sensor control apparatus, a sensor system, and a bridge monitoring system for processing measurement values measured by a sensor element.

Japanese Unexamined Patent Application Publication No. 2008-255570 discloses a technique related to a diagnostic data collection system for a large structure such as a bridge. The diagnostic data collection system disclosed in Japanese Unexamined Patent Application Publication No. 2008-255570 includes a wireless bridge sensor, a data recording device, a data collection device mounted to a traveling vehicle, and a bridge diagnostic device. The wireless bridge sensor measures (i.e., obtains) sensor data at regular intervals and stores the measurement result into the data recording device through wireless communication. The data collection device collects measurements results stored in the data recording device. The bridge diagnostic device receives measurement results from the data collection device when it becomes possible to communicate with the data collection device through a cable or wirelessly as the traveling vehicle moves, and diagnoses the degradation and the soundness of the bridge.

### SUMMARY

In the above-described technique, in order to improve the efficiency of the maintenance and the management of the sensor element that carries out a measurement for an object (or a structure) to be measured, it is conceivable to use one common sensor element for a plurality of purposes (or services) or the like, and analyze and use its measurement results for the respective purposes. However, it is necessary to adjust setting values of the sensor element for measurements so that the sensor element can be shared for the respective purposes, thus making the use of the sensor element complicated. Further, since measurement results obtained by using the same setting values are analyzed for a plurality of intended purposes, there is a possibility that a change in an analyzing logic for one intended purpose could affect other intended purposes. Therefore, a number of restrictions are imposed when the analyzing logic is changed. As a result, there is a problem that it is very difficult to use one sensor element for a plurality of purposes. It should be noted that the aforementioned Japanese Unexamined Patent Application Publication No. 2008-255570 cannot solve this problem.

Other objects and novel features will be more apparent from the following description in the specification and the accompanying drawings.

According to one embodiment, a sensor control apparatus allows each of a plurality of user programs for different purposes to exclusively use a sensor element in a time-sharing manner, and receives maintenance information during execution of that user program.

According to the above-described embodiment, it is possible to efficiently use a sensor element, which measures an object to be measured, for a plurality of purposes.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a schematic configuration of a sensor system according to a first embodiment;

FIG. 2 is a block diagram showing an overall configuration of a sensor system according to the first embodiment;

FIG. 3 is a block diagram showing a configuration of a sensor apparatus according to the first embodiment;

FIG. 4 is a block diagram showing a hardware configuration of the sensor apparatus according to the first embodiment;

FIG. 5 is a block diagram showing a configuration of a concentrator according to the first embodiment;

FIG. 6 is a block diagram showing a configuration of a management server according to the first embodiment;

FIG. 7 is a diagram showing a concept of a daily operation schedule in the sensor apparatus according to the first embodiment;

FIG. 8 shows an example of a list of registered programs according to the first embodiment;

FIG. 9 shows an example of a description of a user program according to the first embodiment;

FIG. 10 is a state transition diagram for states after the sensor apparatus according to the first embodiment is started;

FIG. 11 is a flowchart showing processes of a periodic processing program according to the first embodiment;

FIG. 12 is a flowchart showing processes in a maintenance mode performed on the sensor apparatus side according to the first embodiment;

FIG. 13 is a flowchart showing processes in the maintenance mode performed on the management server side according to the first embodiment;

FIG. 14 is a flowchart showing parallel execution processes of a user program and a periodic processing program managed by a task manager according to the first embodiment;

FIG. 15 is a flowchart showing a user program start-up process according to the first embodiment;

FIG. 16 is a flowchart showing processes of a user program according to the first embodiment;

FIG. 17 is a flowchart showing processes of a deriver program for a sensor element according to the first embodiment;

FIG. 18 is a diagram showing an outline of an information flow in the sensor system according to the first embodiment;

FIG. 19 is a block diagram showing an overall configuration of a sensor system according to a second embodiment;

FIG. 20 is a diagram showing an outline of an information flow in the sensor system according to the second embodiment;

FIG. 21 is a block diagram showing an overall configuration of a bridge monitoring system according to a third embodiment; and

FIG. 22 is a drawing for explaining a concept of monitoring of a bridge by an acceleration sensor.

### DETAILED DESCRIPTION

Specific embodiments to which the above-described means for solving the program is applied are explained hereinafter in detail with reference to the drawings. The same symbols are assigned to the same components throughout the drawings, and duplicated explanation thereof is omitted as appropriate for clarifying the explanation.

In the following embodiments, when necessary, the present invention is explained by using separate sections or separate embodiments. However, those embodiments are not unrelated with each other, unless otherwise specified. That is, they are related in such a manner that one embodiment is a modified example, an application example, a detailed example, or a supplementary example of a part or the whole of another embodiment. Further, in the following embodiments, when the number of elements or the like (including numbers, values, quantities, ranges, and the like) is mentioned, the number is not limited to that specific number except for cases where the number is explicitly specified or the number is obviously limited to a specific number based on its principle. That is, a larger number or a smaller number than the specific number may be also used.

Further, in the following embodiments, their components (including operation steps and the like) are not necessarily indispensable except for cases where the component is explicitly specified or the component is obviously indispensable based on its principle. Similarly, in the following embodiments, when a shape, a position relation, or the like of a component(s) or the like is mentioned, shapes or the likes that are substantially similar to or resemble that shape are also included in that shape except for cases where it is explicitly specified or they are eliminated based on its principle. This is also true for the above-described number or the like (including numbers, values, quantities, ranges, and the like).

### First Embodiment

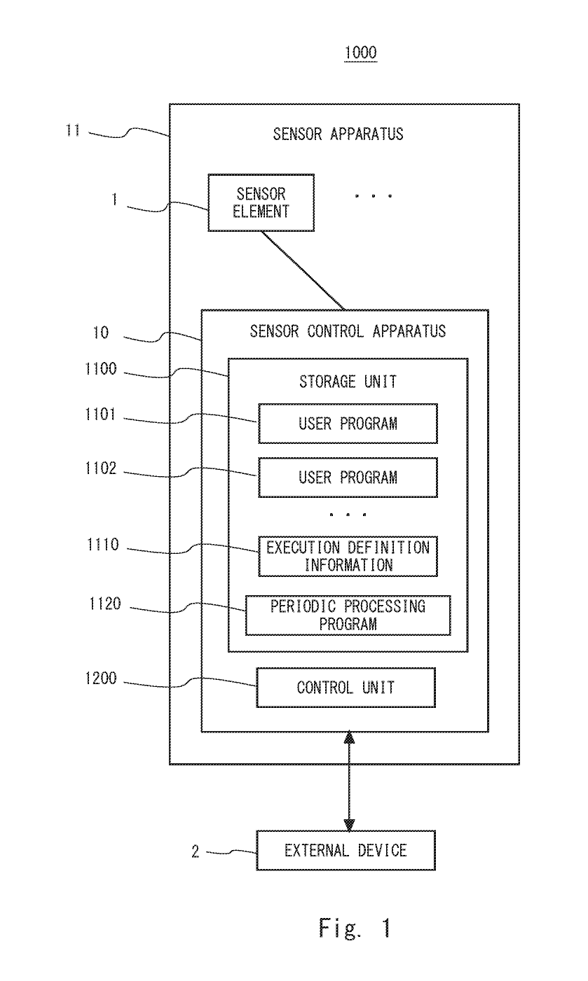

FIG. 1 is a block diagram showing a schematic configuration of a sensor system 1000 according to a first embodiment. The sensor system 1000 includes a sensor apparatus 11 and an external apparatus 2. The sensor apparatus 11 includes a sensor element 1 and a sensor control apparatus 10. The sensor element 1 carries out a measurement for an object to be measured based on setting values. Here, examples of the object to be measured include a bridge, a bridge pier, a road, and a building. However, the object to be measured is not limited to them. Further, examples of the sensor element 1 include an acceleration sensor, a temperature sensor, a battery, and MEMS (Micro Electro Mechanical Systems). However, the sensor element 1 is not limited to them. Further, examples of setting values include a sampling rate, a measurement range, and the number of times of measurements in one measurement operation in an acceleration sensor. Further, examples of setting values also include a sampling rate, and upper and lower limits for an alarm in a temperature sensor. Further, examples of setting values also include a sampling rate, and upper and lower limits for an alarm in a battery. Further, examples of measurement results obtained by the sensor element 1 include vibrations in a bridge.

The sensor control apparatus 10 is connected to at least one sensor element 1. Therefore, the sensor apparatus 11 can be regarded as an apparatus with a sensor element 1 mounted thereto. The sensor control apparatus 10 includes a storage unit 1100 and a control unit 1200. The storage unit 1100 stores a plurality of user programs 1101, 1102, . . . , execution definition information 1110, and a periodic processing program 1120.

Each of the user programs 1101 and so on (hereinafter also called “user programs 1101 etc.”) is a computer program in which a series of processes including making a predetermined setting for the sensor element 1, processing a measurement result based on that setting, and transmitting the processing result to the external apparatus 2 is implemented. That is, a series of processes is implemented in the user program 1101 and a series of processes different from that for the user program 1101 is implemented in the user program 1102.

The execution definition information 1110 is information in which mutually different execution time periods (or execution time slots) are defined for the plurality of the user programs 1101 etc. That is, these execution time periods do not overlap each other. The periodic processing program 1120 is a computer program in which a process for receiving predetermined maintenance information from the external apparatus 2 and a process that is performed based on the maintenance information are implemented. Note that the maintenance information is information that is used to perform a predetermined maintenance process for the sensor apparatus 11. Examples of the maintenance information include information about a change in the initialization setting at the time of the start-up of the sensor apparatus 11, a program for updating firmware, a program for updating a user program. However, the maintenance information is not limited to them. Further, examples of the process based on maintenance information include a process for changing the initialization setting of the sensor apparatus 11, a process for updating firmware, a process for updating a user program.

The control unit 1200 starts executing, among the plurality of user programs 1101 etc., a user program for which the start time of its execution time period has come (i.e., for which the current time coincides with the start time of its execution time period) based on the execution definition information 1110. Further, while the first program is being executed among the plurality of user programs 1101 etc. based on the execution definition information 1110, the control unit 1200 receives predetermined maintenance information from the external apparatus 2 and performs a process based on that maintenance information. That is, during the execution of the first program, the control unit 1200 executes the periodic processing program 1120 in parallel with the first program.

The external apparatus 2 is a server, a concentrator, or the like, which is a computer device capable of communicating with the sensor apparatus 11 through a network or the like. Note that the sever and the concentrator according to this embodiment are described later.

As described above, in this embodiment, a series of processes including setting to one sensor element, processing of measured values, and transmission of processing results is implemented on one user program, and a plurality of such user programs in each of which a different series of processes for its respective intended purpose is implemented are used. Then, a different execution time period is defined for each of the plurality of user programs, thus preventing two or more programs from being simultaneously executed at any moment. Therefore, each of the plurality of user programs can exclusively use the sensor element. That is, when each of the user programs is executed, that user program can make settings for the sensor element in its own way, process measured results obtained with the settings in its own way, and transmit processing results to its own destination. Therefore, it is possible to change details of the implementation of one user program without being affected by the settings and the algorisms of the other user programs. Accordingly, it is possible to efficiently use the sensor element for a plurality of purposes.

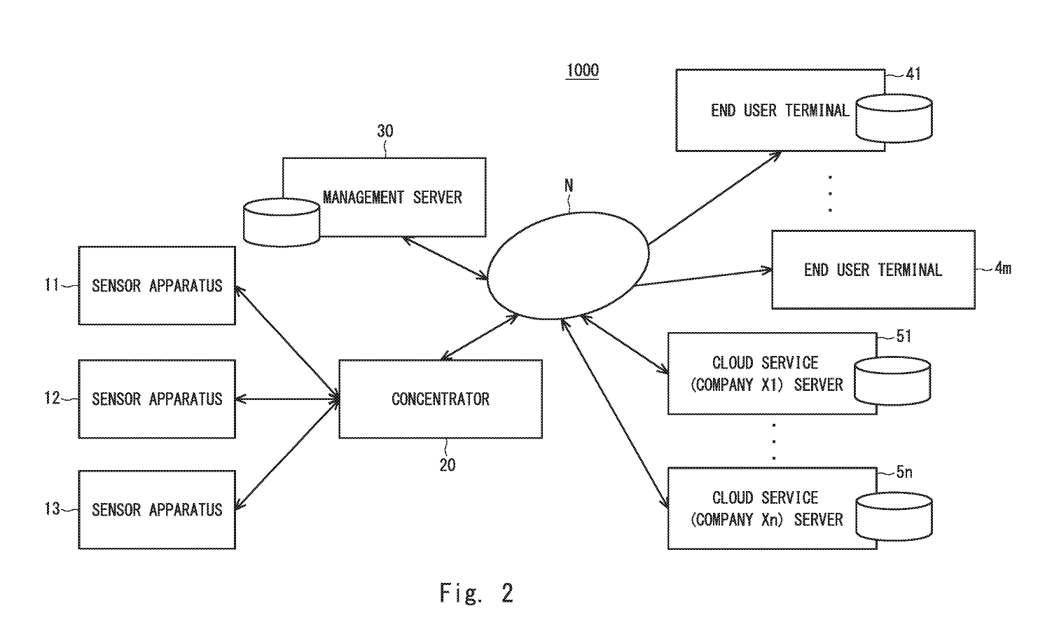

FIG. 2 is a block diagram showing an overall configuration of a sensor system 1000 according to the first embodiment. Note that FIG. 2 shows an example in which the sensor system 1000 is embodied together with the above-described configuration shown in FIG. 1. The sensor system 1000 includes sensor apparatuses 11, 12 and 13, a concentrator 20, a sensor apparatus management server 30, end user terminals 41, . . . , 4m (m is an integer no less than two), and cloud service servers 51, . . . , 5n (n is an integer no less than two).

Each of the sensor apparatuses 11 to 13 is a computer device including a different sensor element mounted thereto and is capable of communicating with the concentrator 20 through a cable or wirelessly. Note that the number of the sensor apparatuses 11 to 13 should be at least one. The concentrator 20 is a computer device that relays data between the sensor apparatuses 11 to 13 and the management server 30. The concentrator 20 includes therein a wired or wireless device capable of connecting with a cloud (i.e., a cloud service or the like) and hence can communicate with the management server 30 through a network N. Note that the network N is an ordinary network infrastructure line. For example, the network N is the Internet or the like. Note that more than one concentrator 20 may be used. For example, a plurality of concentrators may be used depending on the intended condition for the installment of the sensor apparatus 11 and the like.

The management server 30 is a computer device that manages the sensor apparatuses 11 to 13 and the concentrator 20. The management server 30 communicates with the concentrator 20, the end user terminals 41 to 4m, and the cloud service servers 51 to 5n through the network N. Note that the concentrator 20 or the management server 30 corresponds to the above-described external apparatus 2.

Here, assume a management company that manages the sensor apparatuses 11 to 13, the concentrator 20, and the management server 30. Assume that each of companies X1 to Xn that manages the cloud service servers 51 to 5n, respectively, has contracted with the management company in advance and has already received an authentication key distributed by the management company. The authentication key is, for example, unique information assigned to its respective time period (e.g., one hour) in a day that can be exclusively used by the sensor apparatus 11 or the like. Further, each of the companies X1 to Xn develops a user program in which setting of setting values for measurements, a process for processing measurement results, a transmission process of processing results in which a server of that company is defined as the destination, and the like are implemented based on the intended purpose of that company for the sensor element mounted to the sensor apparatuses 11 to 13. Note that the authentication key is also assigned to, in addition to the time period, firmware, information on a change in the initialization setting, and the like.

After that, each of the cloud service servers 51 to 5n transmits, i.e., uploads its respective user program including the authentication key distributed to the own company and the time period (start time) added therein to the management server 30. The management server 30 determines whether or not the combination of the authentication key and the time period added in the user program received from a respective one of the cloud service servers 51 to 5n is appropriate. Then, when the management server 30 determines that the combination is appropriate, the management server 30 adds the combination of the authentication key and the time period added in the received user program in a predetermined description method. Examples of the predetermined description method include describing (i.e., making a note of) the start time and the authentication key at the head of the program code of the user program so that they are regarded as an explanatory note, and describing authentication keys corresponding to times other than the time period added in the user program as blanks. After that, the management server 30 transfers the user program to the concentrator 20. The concentrator 20 transfers the transferred user program to the sensor apparatuses 11 to 13. Each of the sensor apparatuses 11 to 13 stores the transferred user program into a storage unit and records the address at which the user program is stored in a time period (i.e., a time period field) corresponding to the added start time in a list of registered programs (hereinafter also called a “registered program list”), which is an example of the execution definition information. Further, each of the cloud service servers 51 to 5n receives various information items about the sensor apparatus 11 and the like through the concentrator 20 and the management server 30. Note that the management server 30 updates the authentication key at regular intervals or irregular intervals in order to ensure the security. When the management server 30 updates the authentication key, the management server 30 notifies each of the cloud service servers 51 to 5n of a respective updated authentication key corresponding to its contracted time period. Further, the management server 30 transmits the updated authentication key to a respective sensor apparatus, and instructs the sensor apparatus to overwrite (or rewrite) the description of the authentication key in the user program and overwrite (or rewrite) the description of the authentication key in the registered program list.

The end user terminals 41 to 4m are terminal devices operated by end users. Examples of the end user terminals 41 to 4m include a personal computer, a tablet terminal, and a smartphone. However, the end user terminals 41 to 4m are not limited to them. Further, the end user is a company or an individual person that pays a price for a processing result (analysis result) obtained from measurement results of the sensor apparatus 11 or the like provided by the companies X1 to Xn. Each of the end user terminals 41 to 4m accesses the management server 30 based on the access right given by the cloud service servers 51 to 5n, peruses (or browses) data provided by each company, and downloads such data into a storage medium (such as hard disk drive) of the company or the individual person.

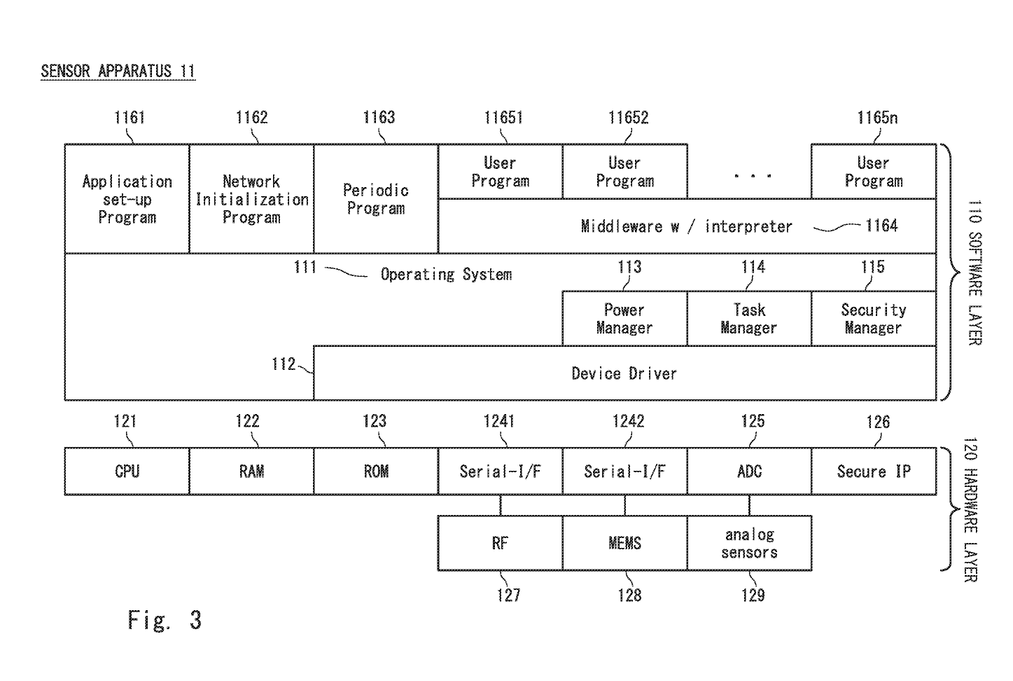

FIG. 3 is a block diagram showing a configuration of the sensor apparatus 11 according to the first embodiment. Note that the configuration of the each of the sensor apparatuses 12 and 13 is similar to that shown in FIG. 3 and therefore their illustrations and explanations are omitted. The sensor apparatus 11 can be divided into two layers, i.e., a software layer 110 and a hardware layer 120. The hardware layer 120 includes a CPU (Central Processing Unit) 121, a RAM (Random Access Memory) 122, a ROM (Read Only Memory) 123, serial I/Fs (InterFaces) 1241 and 1242, an ADC (Analog-to-Digital Converter) 125, a secure IP (Internet Protocol) 126, an RF (Radio Frequency) 127, MEMS (Micro Electro Mechanical Systems) 128, and an analog sensor 129. Note that the RF 127, the MEMS 128, the analog sensor 129 are connected to the main body of the sensor apparatus 11 through the serial I/F 1241, the serial I/F 1242, and the ADC 125, respectively. Note that the sensor element to be connected can be changed according to the object to be measured. Further, the analog sensor 129 is an example of a sensor element that outputs a change in a resistance (R) or a capacitance (C).

The software layer 110 is a layer higher than the hardware layer 120 and includes an operating system 111, a device driver 112, a power manager 113, a task manager 114, a security manager 115, an application set-up program 1161, a network initialization program 1162, a periodic processing program 1163, a middleware/interpreter 1164, and user programs 11651, 11652, . . . , 1165n. The device driver 112 is a driver for enabling the CPU 121 to control a device (e.g., a slave device). In the device driver 112, a process for acquiring data measured (i.e., obtained) by the controlled sensor element, a process for detecting a failure in the sensor element, a process for setting setting values for the sensor element, and the like are implemented. The power manager 113, the task manager 114, and the security manager 115 can be regarded as a management process layer. The task manager 114 and the operating system 111 control execution of the application set-up program 1161, the network initialization program 1162, the periodic processing program 1163, and the middleware/interpreter 1164. In particular, the task manager 114 starts executing the periodic processing program 1163 at regular intervals using a built-in clock (or build-in timer). Further, the task manager 114 refers to the execution definition information 1110 at regular intervals, and thereby selects a user program to be executed on the middleware/interpreter 1164 from among the user programs 11651 to 1165n, and starts and finishes its execution. The application set-up program 1161 is a program in which an initialization setting, which is used upon start-up of the sensor apparatus 11, or the like is implemented. The application set-up program 1161 may also be called an “apparatus set-up program”. The network initialization program 1162 is a program in which a process for enabling the sensor apparatus 11 to establish a network with the concentrator 20 or the like is implemented. The periodic processing program 1163 corresponds to the above-described periodic processing program 1120. Specifically, in the periodic processing program 1163, a process for synchronizing a time with the management server 30 through the concentrator 20, a process for checking whether or not there is a change in the information of the sensor apparatus 11, and the like are implemented. The middleware/interpreter 1164 supports execution of the user programs 11651 to 1165n and performs interpreter-type language processing. Each of the user programs 11651 to 1165n can be regarded as an uppermost application layer and is a program describing a specific operation method for the sensor apparatus designed by a cloud service company. That is, in each of the user programs 11651 to 1165n, definitions of setting values for measurements for the sensor element, a process for receiving measurement results obtained by the sensor element, a process for processing measurement results (sensor information) (such as a numerical calculation process necessary for the calculation of sensor information), a definition of a communication format, a process for generating communication data by converting the sensor information based on the communication format, and so on are implemented by using an interpreter-type language. By using the interpreter-type user program as described above, it is possible to eliminate the dependence of the CPU on the architecture, ensure the operation so that a plurality of user programs do not interfere with each other, and reduce the cost and the time related to the preparation of a developing environment for a software development by a cloud service company, the programing skill therefor, and the like.

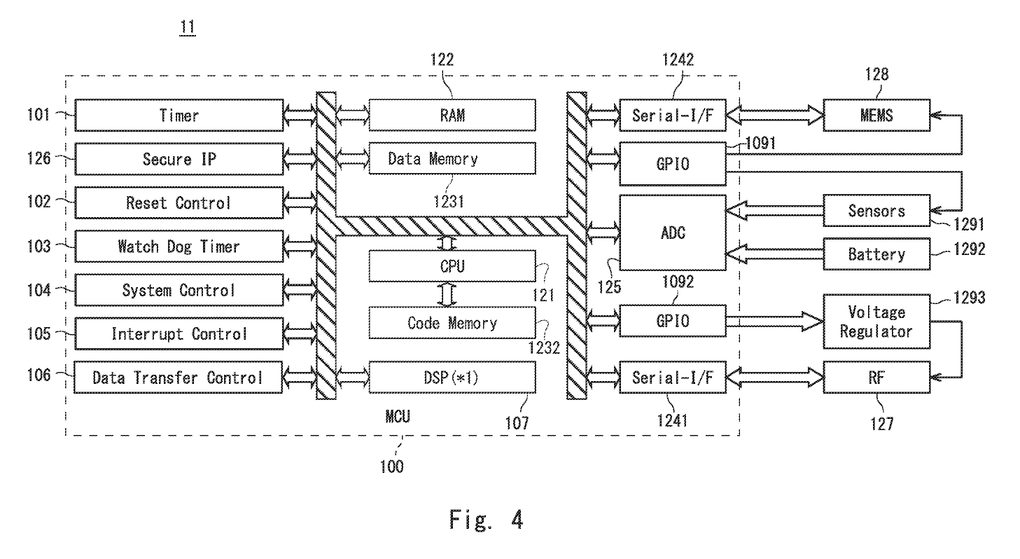

FIG. 4 is a block diagram showing a hardware configuration of the sensor apparatus 11 according to the first embodiment. In FIG. 4, power supply lines are shown. The sensor apparatus 11 includes an MCU (Micro Control Unit) 100 as an example of the sensor control apparatus 10. The MCU 100 includes a timer 101, a secure IP 126, a reset control 102, a watch dog timer 103, a system control 104, an interrupt control 105, a data transfer control 106, a RAM 122, adatamemory 1231, a CPU 121, a code memory 1232, a DSP (Digital Signal Processor) 107, a serial I/F 1242, a GPIO (General Purpose Input/Output) 1091, an ADC 125, a GPIO 1092, and a serial I/F 1241. Note that the MEMS 128 is connected to the MCU 100 through the serial I/F 1242. The sensor 1291 is connected to the MCU 100 through the GPIO 1091 and the ADC 125. Further, a battery 1292, a voltage regulator 1293, and the RF 127 are connected to the MCU 100 through the ADC 125, the GPIO 1092, and the serial I/F 1241, respectively.

Since the power consumption of the MEMS 128 and the analog sensor 1291 is small, they can be supplied with electric power through the GPIO 1091 port of the MCU 100. By supplying electric power directly to the sensor 1291 through the GPIO 1091, the sensor 1291 can be powered on/off at an arbitrary timing. As a result, the power consumption of the sensor apparatus 11 can be reduced. In contrast to this, for the RF 127 for which there is a concern that its power supply ability could be insufficient, an operation control terminal of a regulator is controlled from the MCU 100 so that the RF 127 is powered off when it is not used as in the case of the sensor 1291.

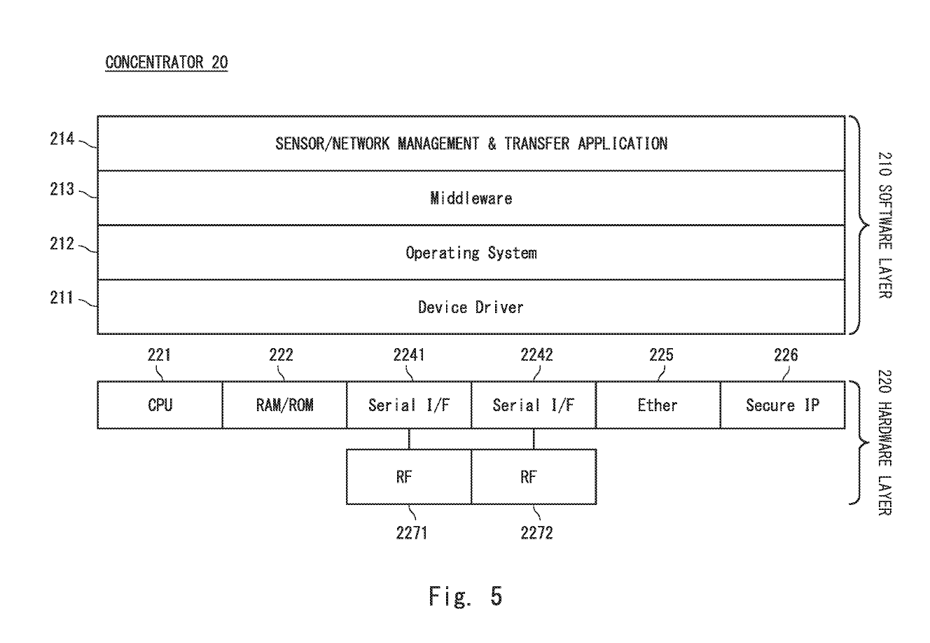

FIG. 5 is a block diagram showing a configuration of the concentrator 20 according to the first embodiment. The concentrator 20 can be divided into two layers, i.e., a software layer 210 and a hardware layer 220. The hardware layer 220 includes a CPU 221, an RAM/ROM 222, serial I/Fs 2241 and 2242, an Ether 225, a secure IP 226, and RFs 2271 and 2272. Note that the RFs 2271 and 2272 are connected to the main body of the concentrator 20 through the serial I/Fs 2241 and 2242, respectively. Note that the RFs 2271 and 2272 are an example of wireless devices and the number of the RFs should be at least one.

The software layer 210 is a layer higher than the hardware layer 220 and includes a device driver 211, an operating system 212, a middleware 213, and a sensor network management and transfer application 214. The operating system 212, the middleware 213, and the sensor network management and transfer application 214 provide a bridge function between a plurality of communication networks that enable a connection with the network N (e.g., the Internet connection) by the Ether 225. Note that since this bridge function is required to have a high response property to each of the communication networks, the CPU 221 may have a multi-CPU architecture.

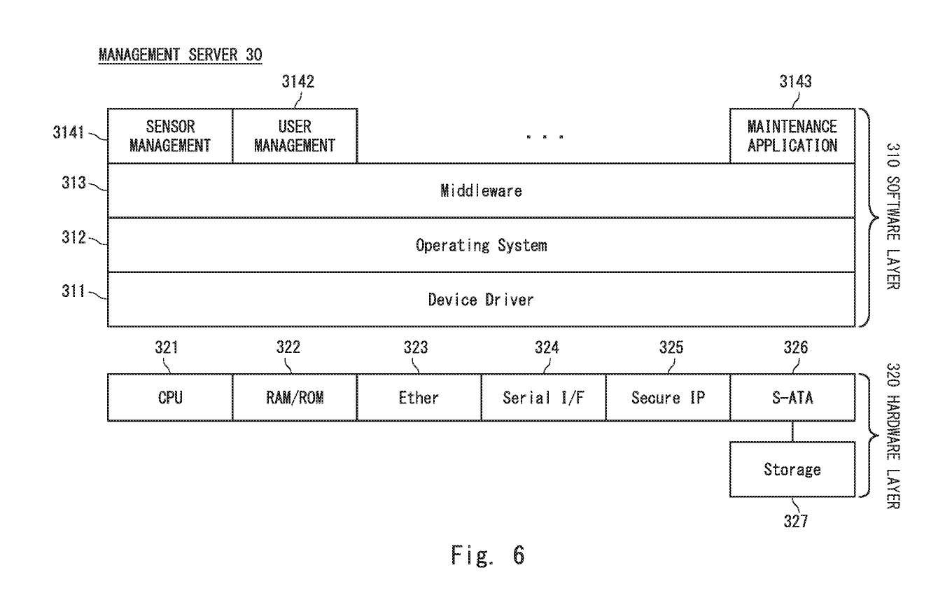

FIG. 6 is a block diagram showing a configuration of the management server 30 according to the first embodiment. The management server 30 can be divided into two layers, i.e., a software layer 310 and a hardware layer 320. The hardware layer 320 includes a CPU 321, an RAM/ROM 322, an Ether 323, a serial I/F 324, a secure IP 325, an S-ATA (Serial ATA) 326, and a storage 327. Note that the storage 327 is connected to the main body of the management server 30 through the S-ATA 326. The secure IP 325 determines whether or not the authentication key, which is added in information transmitted from the cloud service server 51 or the like, is appropriate and supports it.

The software layer 310 is a layer higher than the hardware layer 320 and includes a device driver 311, an operating system 312, a middleware 313, a sensor management 3141, a user management 3142, . . . , and a maintenance application 3143. In particular, the sensor management 3141 and the user management 3142 are application software for supporting exchanges with cloud service companies. Further, the maintenance application 3141 is maintenance software for allowing the management company to perform maintenance.

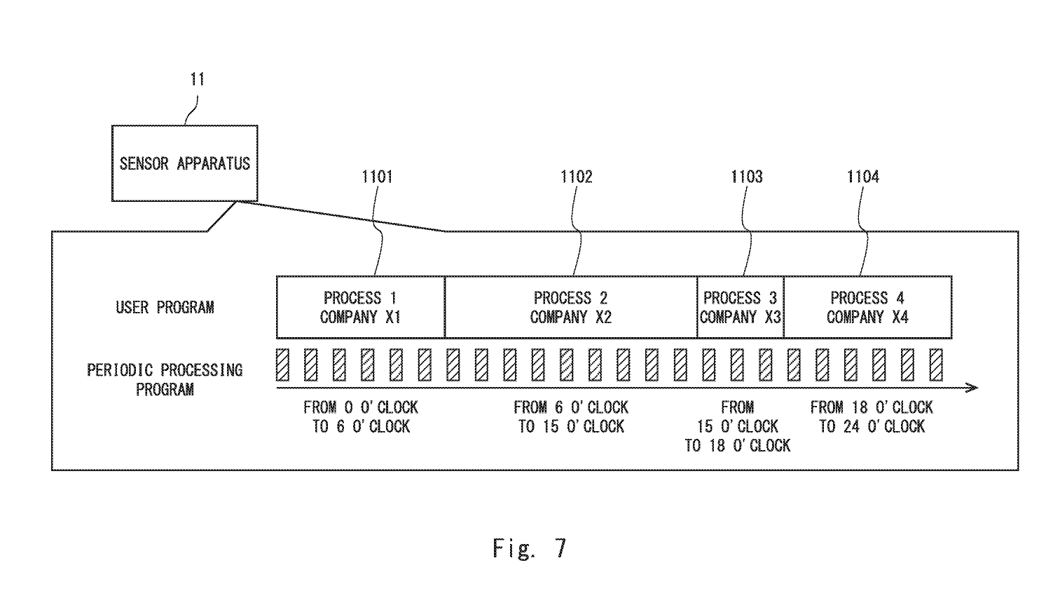

FIG. 7 is a diagram showing a concept of a daily operation schedule in the sensor apparatus 11 according to the first embodiment. That is, FIG. 7 is a conceptual example of definitions in the above-described execution definition information 1110. Firstly, the periodic processing program 1120 is scheduled to be started up at intervals of one hour from 00:00:00 to 23:00:00 every day. That is, the periodic processing program 1120 is scheduled to be started up 24 times per day. It is assumed that one execution time of the periodic processing program 1120 in the sensor apparatus 11 is less than one hour. Further, in the user programs 1101, 1102, 1103 and 1104, a process 1 of a company X1, a process 2 of a company X2, a process 3 of a company X3, and a process 4 of a company X4, respectively, are implemented. Further, the user programs 1101, 1102, 1103 and 1104 are scheduled so that they are started up at 00:00:00, 06:00:00, 15:00:00, and 18:00:00, respectively, every day. That is, an execution time period from 00:00:00 to 05:59:59 is allocated to the user program 1101 every day. An execution time period from 06:00:00 to 14:59:59 is allocated to the user program 1102 every day. An execution time period from 15:00:00 to 17:59:59 is allocated to the user program 1103 every day. Further, an execution time period from 18:00:00 to 23:59:59 is allocated to the user program 1104 every day. In other words, it is ensured that each of the user programs 1101 to 1104 can be executed exclusively from the other user programs in its allocated execution time period. Further, each of the user programs can exclusively use settings and measurement results of the sensor element connected to the sensor control apparatus 10 as well as the resources of the communication device of the sensor control apparatus 10. Further, owing to the exclusive use of the resources, each user program can acquires temporarily-consecutive measurement results from the sensor element without omission.

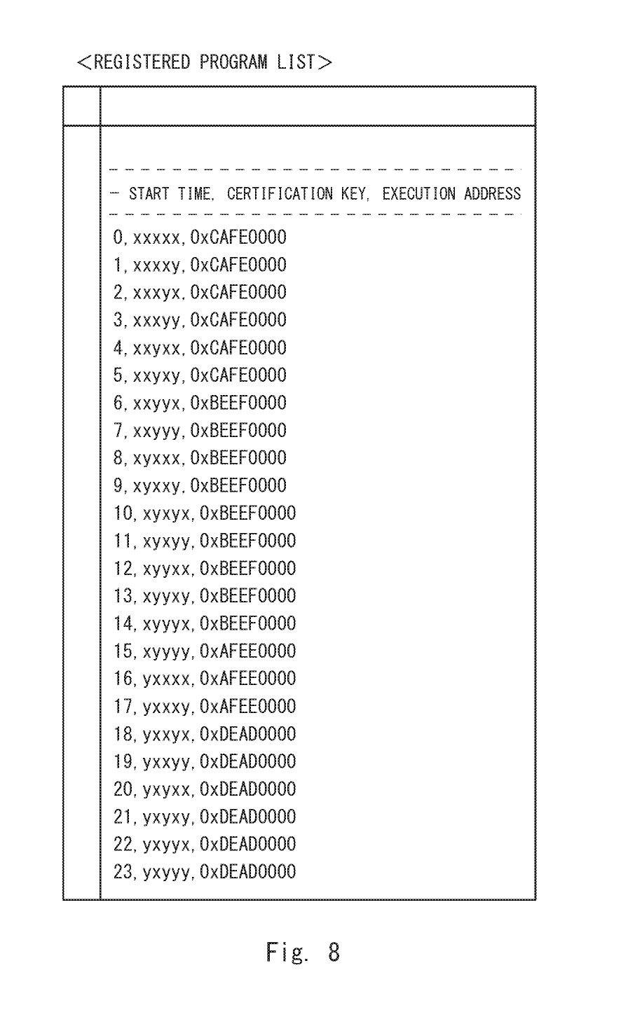

FIG. 8 shows an example of a list of registered programs according to the first embodiment. Note that the registered program list is an example of the execution definition information 1110. In the registered program list, 24 combinations each of which consists of a start time of a user program, an authentication key, and an execution address and which correspond to 0 o'clock to 23 o'clock, respectively, are defined. Note that the start time is expressed by “hours” alone. That is, since “minutes” and “seconds” are both fixed to zero, they are omitted. The authentication key is an example of the above-described authentication information. That is, the authentication key is a value that varies according to the time. The execution address is information on an address at which the respective user program is stored in the storage unit of the sensor control apparatus 10. Note that the registered program list is not limited to the above-shown example. That is, the start time does not necessarily have to be defined by on an hour-by-hour basis. The start time may include a year, a month, and/or a day. Further, the start time may include an hour (i.e., a time of day), a minute, and/or a second. Further, a pair of a start time and an end time may be defined. However, only one user program should be defined at any certain time.

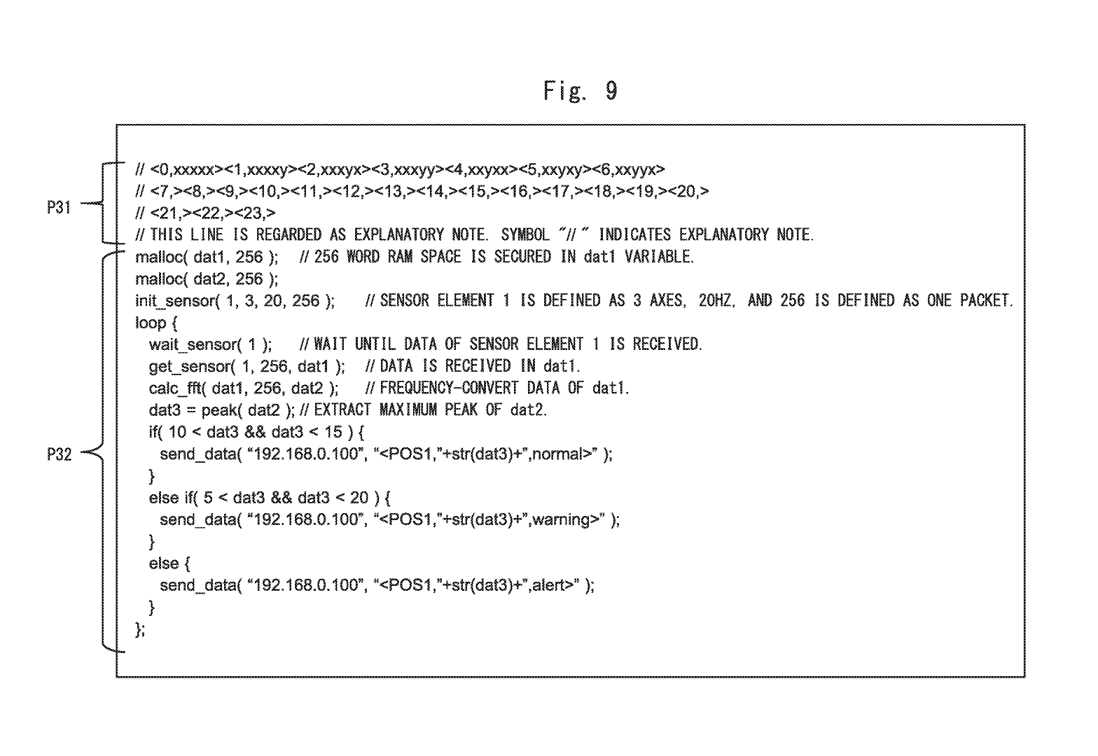

FIG. 9 shows an example of a description of a user program according to the first embodiment. Firstly, a code section P32 is what is implemented in a user program by a company or the like, which is a user of the sensor apparatus. Further, a code section P31 is what is added by the management server that has received the user program from a company or the like when the management server has determined that the user program is appropriate. The code section P31 is described as an explanatory note in the interpreter language. In this example, symbols that are regarded as explanatory notes are added at the beginning of each line of the code section P31, followed by pairs of start times and authentication keys each of which is enclosed by delimiters (“< >” in this example). Note that there is no restriction on the number of lines of the code section P31. Further, authentication keys corresponding to time periods other than the time periods in which the user programs are executed are not recorded. Even if an inappropriate authentication key is recorded for a time period other than the time periods in which the user programs are executed, that authentication key is regarded as an error because its letters are inappropriate and is not registered in the sensor apparatus.

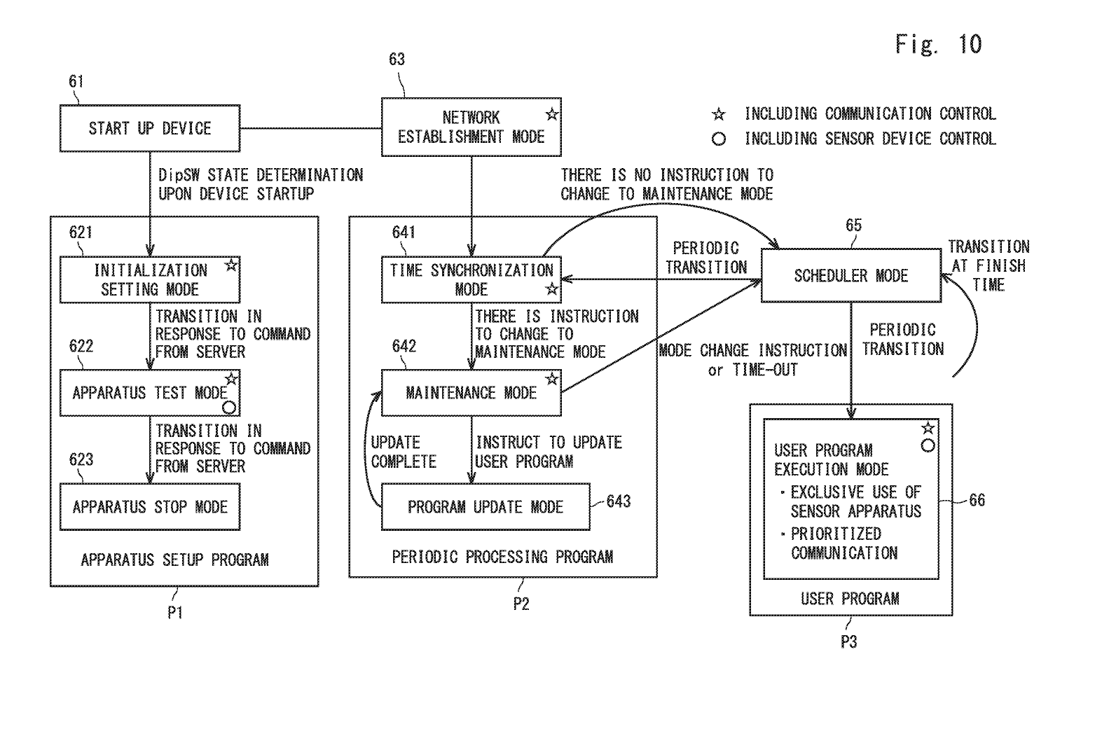

FIG. 10 is a state transition diagram for states after the sensor apparatus 11 according to the first embodiment is started up. An operation of the sensor apparatus 11 is explained step by step from the start-up of the sensor apparatus 11 with reference to FIG. 10. Firstly, the sensor apparatus 11 includes a switch (not shown) mounted thereto. A user can set one of two start-up modes by switching the switch. For the switch, for example, a mechanical switch such as a DIP switch or a jumper switch that changes an electric signal line can be used. Further, the two start-up modes may be an initialization setting mode and a network establishment mode. The initialization setting mode is set before the sensor apparatus 11 is installed in an object to be measured. In contrast to this, the network establishment mode is set after the sensor apparatus 11 is actually installed in an object to be measured. Firstly, a case where the switch is set to the initialization setting mode is explained.

The sensor apparatus 11 determines the start-up mode based on the setting of the switch by a device start-up 61. When the start-up mode is the initialization setting mode, the sensor apparatus 11 changes to an initialization setting mode 621 and starts the application set-up program 1161 (apparatus set-up program P1). In the initialization setting mode 621, the sensor apparatus 11 sets network information necessary to operate the sensor apparatus 11 and initialization settings for the sensor apparatus 11, and updates installed firmware. After that, the sensor apparatus 11 changes to an apparatus test mode 622. In the apparatus test mode 622, the sensor apparatus 11 connects to a server on a pseudo environment through a cable or wirelessly and carries out a test for the apparatus in order to check whether the settings to the apparatus has been correctly made. In this case, it is possible not only to carry out the test for checking the normally-operating system of the apparatus, but also, on the assumption that the network is hacked, to check whether or not an operation for eliminating or ignoring an invalid connection is correctly performed. A series of operations that is performed on the assumption that the network is hacked may be manually performed by sending commands and the like from a terminal on the server side. Alternatively, a series of checking operations may be automatically performed by a test program. When the sensor apparatus 11 has passed the test in the apparatus test mode 622, the sensor apparatus 11 changes to an apparatus stop mode 623 and stopes the sensor apparatus 11 itself. When the sensor apparatus 11 has failed to pass the test, the sensor apparatus 11 transmits the item of the test that the sensor apparatus 11 has failed together with communication log data to the server. In this way, it can be used as information that is used when making contact with the manufacturer. Note that the mode of the sensor apparatus 11 may be changed from the initialization setting mode 621 to the apparatus test mode 622 and to the apparatus stop mode 623 in response to commands sent from the server.

On the other hand, when the switch is set to the network establishment mode, the sensor apparatus 11 determines that the start-up mode is the network establishment mode by the device start-up 61 and changes its mode to a network establishment mode 63. In the network establishment mode 63, the sensor apparatus 11 starts the network initialization program 1162. Then, the sensor apparatus 11 performs a procedure for taking part in a network based on the network information set in the initialization setting mode 621. After the network is established, the sensor apparatus 11 changes its mode to a time synchronization mode 641 for setting a clock in the device.

In the sensor apparatus 11, after the start-up, the task manager 114 is executed and hence a transition to each mode and the start-up of a program are controlled.

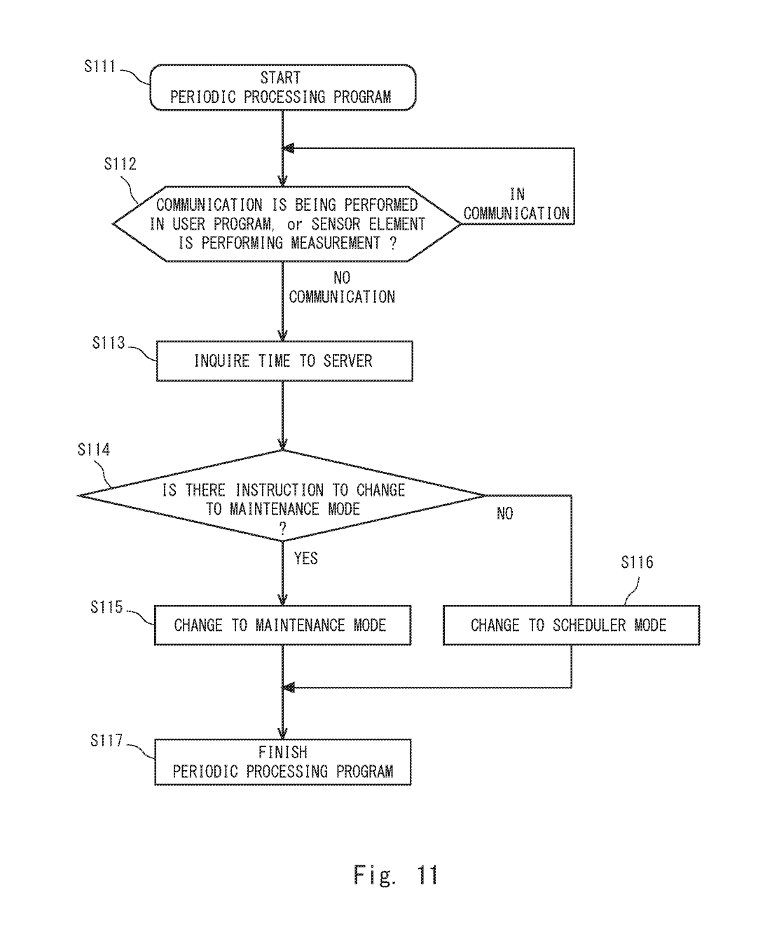

FIG. 11 is a flowchart showing processes of a periodic processing program according to the first embodiment. Firstly, in the time synchronization mode 641, the sensor apparatus 11 starts a periodic processing program P2 (S111). Next, when the user program is executed, the sensor apparatus 11 determines whether the user program is communicating with the concentrator 20 or the sensor element is performing measurement (S112). When the user program is performing communication or the sensor element is performing measurement, the sensor apparatus 11 waits a certain time and then performs the determination in the step S112 again. When no user program is in execution or when neither communication nor measurement is being performed, the sensor apparatus 11 proceeds to a step S113. Note that when the mode of the sensor apparatus 11 is changed from the network established mode 63, no user program is in execution. Further, when a process for processing a measurement result or the like is being performed, it is considered that neither communication nor measurement is being performed even when the user program is in execution.

Next, the sensor apparatus 11 transmits a time inquiry request to the management server 30 through the concentrator 20 (S113). Then, the sensor apparatus 11 receives information on the current time in the management server 30 and, in some cases, a response message including an instruction to change to a maintenance mode from the management server 30 through the concentrator 20. In this way, the sensor apparatus 11 sets the received time information in the internal clock and thereby synchronizes its time with the time in the management server 30. That is, when the sensor element is not in operation and no transmission is being performed to the external apparatus while the first program is in execution, the control unit synchronizes its time with the time of the external apparatus. As a result, it is possible to accurately set the time in the sensor apparatus without affecting the measurement time of measurement results and the transmission process of processing results.

Then, the sensor apparatus 11 determines whether or not an instruction to change to a maintenance mode is included in the received response message (S114). Specifically, it is assumed that a flag or a command indicating the presence/absence of an instruction to change to a maintenance mode is included in the response message. When the change instruction is included in the response message, the sensor apparatus 11 changes its mode to the maintenance mode 642. After the process in the maintenance mode 642 is finished, the sensor apparatus 11 finishes the execution of the periodic processing program P2 (S117). Further, when the change instruction is not included in the response message in the step S114, the sensor apparatus 11 changes its mode to a scheduler mode 65 (S116) and finishes the execution of the periodic processing program P2 (S117).

In the maintenance mode 642, the sensor apparatus 11 performs a maintenance process such as a change in the setting information set in the initialization setting mode, an update of the user program, or an update of the firmware of the sensor apparatus 11 according to the maintenance information received from the management server 30. In particular, the maintenance information includes the authentication key. Therefore, when the sensor apparatus 11 receives the maintenance information, the sensor apparatus 11 sends back that maintenance information to the management server 30 to make the management server 30 verifies the maintenance information. Then, when the result of the verification of the maintenance information in the management server 30 is normal, the sensor apparatus 11 performs a process based on that maintenance information. In this way, even when the user program is in execution, the sensor apparatus 11 can safely perform the process based on the verified maintenance information in parallel with the user program. A detailed explanation is given hereinafter.

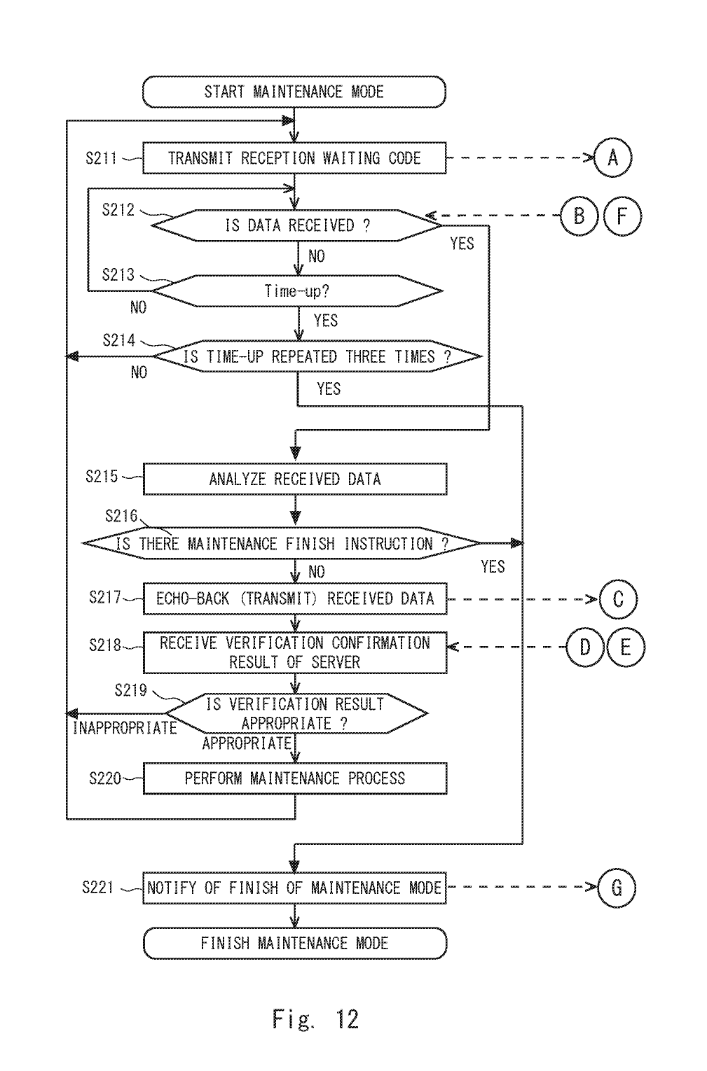

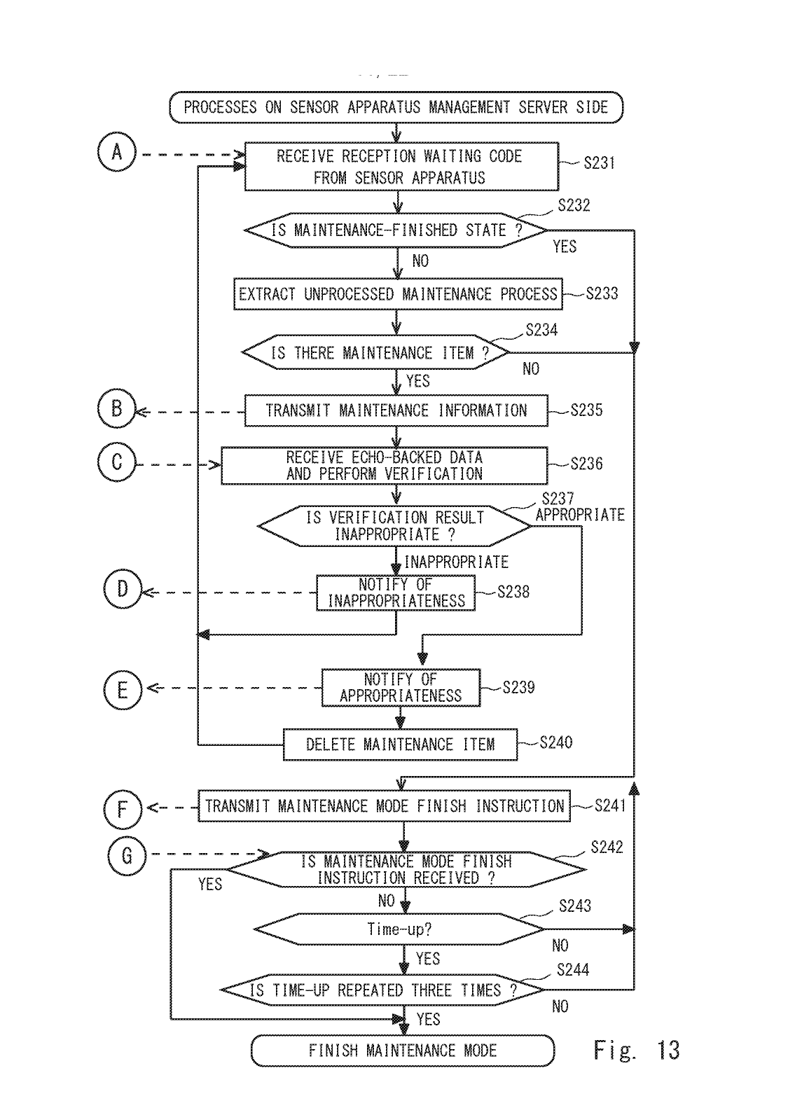

FIG. 12 is a flowchart showing processes in a maintenance mode performed on the sensor apparatus side according to the first embodiment. Further, FIG. 13 is a flowchart showing processes in the maintenance mode performed on the management server side according to the first embodiment. The following explanation is given by referring to FIGS. 12 and 13 as appropriate. Note that in the following explanation, the explanation of the fact that transmission and reception between the sensor apparatus 11 and the management server 30 is carried out through the concentrator 20 is omitted.

Firstly, the sensor apparatus 11 transmits a reception waiting code indicating that the sensor apparatus 11 is waiting for maintenance information to the management server 30 (S211). Note that when the step S211 is performed the next time or the subsequent time, the sensor apparatus 11 may incorporate a determination result in the later-described step S219, an already-processed maintenance code, which is a normal finish notification of a maintenance process in the later-described step S220, and the like into the reception waiting code and transmit the reception waiting code including these information items to the management server 30. Then, the sensor apparatus 11 waits a certain time and receives maintenance information from the management server 30 (S212).

Further, in FIG. 13, the management server 30 receives the reception waiting code from the sensor apparatus 11 in response to the step S211 (S231). Then, the management server 30 determines whether or not the sensor apparatus 11 is in a maintenance finished state (S232). When the sensor apparatus 11 in the maintenance finished state, the management server 30 proceeds to a step S232, and when the sensor apparatus 11 requires maintenance, proceeds to a step S233.

Since maintenance information has not been transmitted yet at this point, the management server 30 extracts a maintenance process that has not been processed yet (S233). Then, the management server 30 determines whether or not there is a maintenance item (S234). For example, when a change in the initialization setting of the sensor apparatus 11 or an update program for the firmware is registered in the management company, when an update program for the user program from the company X1 or the like is registered, or when an authentication key for an update is registered, it means that there is a maintenance item. When there is a maintenance item, the management server 30 transmits the extracted maintenance process data to the sensor apparatus 11 as maintenance information (S235). Note that the maintenance information to be transmitted includes an authentication key. In particular, when the maintenance information is an update program for a user program, combinations of a plurality of start times and a plurality of authentication keys corresponding to the respective start times are recorded in a predetermined area of the user program as explained previously.

Returning to the process of the sensor apparatus 11 shown in FIG. 12, the sensor apparatus 11 determines whether or not the sensor apparatus 11 has received data from the management server 30 (S212). When the sensor apparatus 11 has not received data, the sensor apparatus 11 determines whether or not a waiting time has elapsed, i.e., whether or not the time for the maintenance mode has expired (S213). Note that the upper limit of the waiting time is, for example, five minutes. However, the sensor apparatus 11 can change the upper limit of the waiting time in the initialization setting or in the maintenance mode through an instruction or the like from a user for reasons such as the management of the network, the setting environment, and the number of sensor apparatuses on the same network. When the time has not been expired, the sensor apparatus 11 returns to the step S212. When the time has been expired, the sensor apparatus 11 determines whether or not the time has been expired three times in a row (S214). That is, the sensor apparatus 11 determines whether or not the step S211 is performed three times in a row without receiving data in the step S212 and the time is expired in the step S213 in each of these three times. When the time has been expired only once or twice in a row, the sensor apparatus 11 returns to the step S211. On the other hand, when the time has been expired three times in a row, the sensor apparatus 11 proceeds to a step S221.

Further, in the step S212, when the sensor apparatus 11 has received maintenance information from the management server 30, the sensor apparatus 11 analyzes the received data (S215) and determines whether or not the received data is a maintenance finish instruction (S216). When the received data is a maintenance finish instruction, the sensor apparatus 11 proceeds to the step S221. Note that the maintenance finish instruction may be an instruction to change to a scheduler mode.

On the other hand, when the received data is not a maintenance finish instruction, the sensor apparatus 11 echoes back the received data to the management server 30 (S217). That is, the sensor apparatus 11 sends back the received maintenance information to the management server 30 without processing the maintenance information.

Then, in FIG. 13, the management server 30 receives the echoed-back data, verifies the echoed-back data (S236), and determines whether or not the verification result is appropriate (S237). When the verification result is inappropriate, the management server 30 transmits an inappropriateness notification to the sensor apparatus 11 (S238). On the other hand, when the verification result is appropriate, the management server 30 transmits an appropriateness notification to the sensor apparatus 11 (S239) and deletes the corresponding maintenance item from the unprocessed maintenance processes (S240). After the step S238 or S240, the management server 30 returns to the step S231. Further, in FIG. 12, the sensor apparatus 11 receives the verification result from the management server 30 (S218) and determines whether or not the verification result is appropriate (S219). When the verification result is appropriate, the sensor apparatus 11 performs the maintenance process (S220). Note that the maintenance process is described later.

When the verification result is inappropriate in the step S219 or after the step S220, the sensor apparatus 11 returns to the step S211 and transmits the reception waiting code to the management server 30 again. Here, since the step S211 is performed for the second time, the sensor apparatus 11 may incorporate the determination result in the step S219, an already-processed maintenance code, i.e., a normal finish notification of the maintenance process in the step S220, and the like into the reception waiting code and transmit the reception waiting code including these information items to the management server 30 as described above.

Further, when the sensor apparatus 11 is not in the maintenance finished state in the step S232 in FIG. 13 and there is a maintenance item (Yes at S234), the management server 30 transmits different maintenance information to the sensor apparatus 11 and performs the subsequent processes as described above. Then, when the sensor apparatus 11 receives the different maintenance information, the sensor apparatus 11 subsequently performs the maintenance process. On the other hand, when there is no maintenance information in the management server 30 (No at S234) or when the sensor apparatus 11 in the maintenance finished state in the step S232, the management server 30 transmits a maintenance mode finish code to the sensor apparatus 11 (S241). Then, in FIG. 12, the sensor apparatus 11 receives the maintenance mode finish code (Yes at S212), determines that it is a maintenance finish instruction (Yes at S216), and proceeds to the step S221. Then, the sensor apparatus 11 transmits a maintenance mode finish notification to the management server 30 (S221). Further, the sensor apparatus 11 finishes the maintenance mode process and changes its mode to a scheduler mode 65. Further, in FIG. 13, the management server 30 receives the maintenance mode finish notification from the sensor apparatus 11 (Yes at S242) and finishes the maintenance mode. However, when the management server 30 cannot receive the maintenance mode finish notification in the step S242, the management server 30 determines whether or not the time has been expired (S243). Then, when the time has not been expired, the management server 30 returns to the step S241. When the time has been expired, the management server 30 determines whether or not the time has been expired three times in a row (S244). When the time has been expired only once or twice in a row, the management server 30 returns to the step S241. On the other hand, when the time has been expired three times in a row, the management server 30 finishes the maintenance mode.

Note that the above-described maintenance process corresponds to the above-described “process based on maintenance information”. For example, the maintenance process is a process for changing the initialization setting of the sensor apparatus 11, a process for updating firmware, a process for updating a user program, a process for changing an authentication key, or the like. Firstly, when the maintenance process is a process for changing the initialization setting of the sensor apparatus 11, the maintenance information includes a change in the initialization setting of the sensor apparatus 11. Further, when the change process can be performed, the sensor apparatus 11 updates values in the initialization setting to values according to the change. Then, if necessary, the sensor apparatus 11 carries out an apparatus test, establishes a network, and so on. Therefore, the above-described change process may use part of the application set-up program 1161 and the network initialization program 1162.

Further, when the maintenance information is a process for updating firmware, the maintenance information includes an update program for the firmware. Further, the sensor apparatus 11 stores the update program in a storage area different from that for the current firmware. When the update process for the firmware can be performed, the sensor apparatus 11 replaces the current firmware with the update program and executes the update program.

Further, when the maintenance information is a process for changing an authentication key, the maintenance information includes a combination of a replacement authentication key and a start time. Further, the sensor apparatus 11 overwrites (rewrites) the authentication key that is recorded in association with a corresponding start time in the registered program list with the replacement authentication key included in the maintenance information. At the same time, the sensor apparatus 11 also overwrites (or rewrites) the authentication key recorded in association with a corresponding start time in a user program that is stored at an execution address recorded in association with a corresponding start time in the registered program list with the replacement authentication key included in the maintenance information.

Further, when the maintenance information is a process for updating a user program, the maintenance information includes an update program for the user program. Further, a combination of a start time and an authentication key is recorded in a predetermined area in the update program. Further, the sensor apparatus 11 stores the update program in a storage area different from that for the current user program. Further, the sensor apparatus 11 searches the registered program list for a combination of a start time and an authentication key that matches the combination of the start time and the authentication key recorded in the update program. After that, the sensor apparatus 11 overwrites the execution address corresponding to the combination of the start time and the authentication key retrieved from the registered program list with the address at which the update program is stored. Note that in this case, the sensor apparatus 11 changes its mode to a program update mode 643 and, after the update, returns to the maintenance mode 643.

In other words, during the execution of a first program, the control unit receives an update program for a second program among a plurality of programs from the management server 30 as maintenance information, adds and stores that update program in the storage unit, and starts executing the update program instead of executing the second program at the execution start time of the second program based on the execution definition information. In this way, even during the execution of one user program, the control unit can safely update another user program and appropriately execute the update program.

Further, the execution definition information may include the storage destination of each program in the storage unit as an execution address. The control unit preferably starts the execution of each of a plurality of programs stored at the execution address corresponding to its respective start time at the start time of the execution time period for the respective program, overwrites the execution address in the second program in the execution definition information with the storage destination of the update program, and starts executing the update program by referring to the execution definition information and reading out the update program from the execution address in the second program at the start time of the execution time period in the second program. In this way, it is possible to appropriately update the reference destination of the other user program without affecting the user program that is currently in execution.

Alternatively, during the execution of the first program, the control unit receives an update program for the first program from the external apparatus as maintenance information, stores the update program in a storage destination different from that for the first program in the storage unit, and when the execution of the first program is finished and then the execution thereof is started again based on the execution definition information, starts executing the update program instead of executing the first program. In this way, even when an update program for a user program that is currently in execution is received, the control unit can safely receive the update program and appropriately execute it in the next execution time.

Note that at the moment when the mode has not yet been changed from the current maintenance mode 642 to the later-described scheduler mode 65, i.e., at the moment when the mode has been merely changed from the network establishment mode (through the time synchronization mode 641), the user program has not executed yet. Further, when the mode has been changed from the scheduler mode 65 to the current maintenance mode 642 (through the time synchronization mode 641), the user program is in execution at that moment. Therefore, when the user program has not yet been executed, it corresponds to the state where the “change process” or the “firmware update process” is “can be performed”. Therefore, as the maintenance process, any of the process for changing the initialization setting, the process for updating firmware, the process for changing an authentication key, and the process for updating a user program can be performed.

On the other hand, when the user program is in execution, the control unit puts the process for changing the initialization setting and the process for updating the firmware on holds (i.e., postpones them) and restarts the sensor apparatus 11. For example, the control unit waits until the currently-executed user program is finished and, after the finish of the user program, restarts the sensor apparatus 11. To this end, the sensor control apparatus may be configured as follows. That is, the maintenance information may include setting information for the sensor control apparatus and the control unit may store the received maintenance information in an area in the storage unit that is read out as the initialization setting upon restart of the sensor control apparatus. Alternatively, the maintenance information may include an update program for the firmware for the sensor control apparatus and the control unit may store the received update program in an area for updating the firmware of the sensor apparatus in the storage unit and update the firmware by using the update program stored in the area for the update upon restart of the sensor control apparatus. In this way, it is possible to safely perform a maintenance process without affecting the operation of the currently-executed user program.

Next, the scheduler mode 65 is explained. Firstly, the sensor apparatus 11 changes from the time synchronization mode 641 or the maintenance mode 642 to the scheduler mode 65. Then, the sensor apparatus 11 periodically changes its mode to the time synchronization mode 641 by starting up a periodic processing program P2 and in parallel with this, changes its mode to a user program execution mode 66 by starting up a user program P3 based on the execution definition information 1110. The control for these processes is performed by the task manager 114 as described previously.

In other words, the storage unit further stores a periodic processing program in which a process for receiving the predetermined maintenance information from the external apparatus and a process based on this maintenance information are implemented, and the control unit starts executing one of the plurality of programs based on the execution definition information and starts the execution of the periodic processing program at predetermined intervals. In this way, it is possible to execute a maintenance process without suspending the measurement by the sensor element and the process for processing the user program.

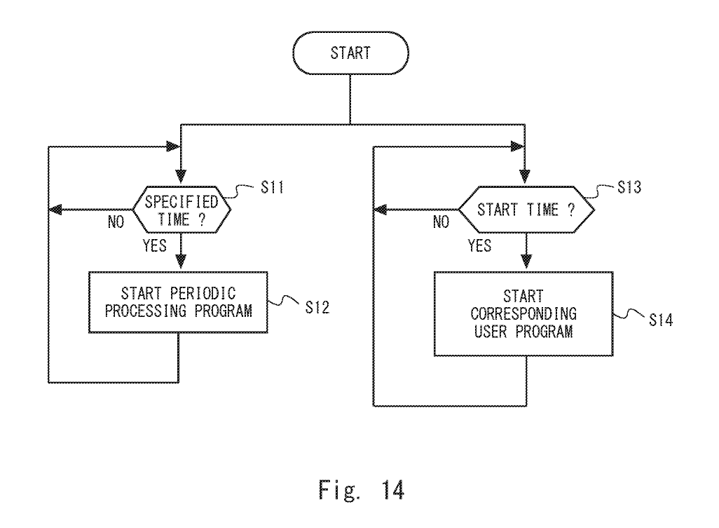

FIG. 14 is a flowchart showing parallel execution processes of a user program and a periodic processing program managed by a task manager according to the first embodiment. Firstly, the task manager 114 determines whether or not it is a specified time (S11). For example, the task manager 114 determines whether or not the current time becomes “00 minute 00 second” of an arbitrarily-determined time of day by using a built-in timer. When it is the specified time, the task manager 114 performs a process for starting up the periodic processing program P2 (S12). Specifically, the task manager 114 performs the above-described process shown in FIG. 11.

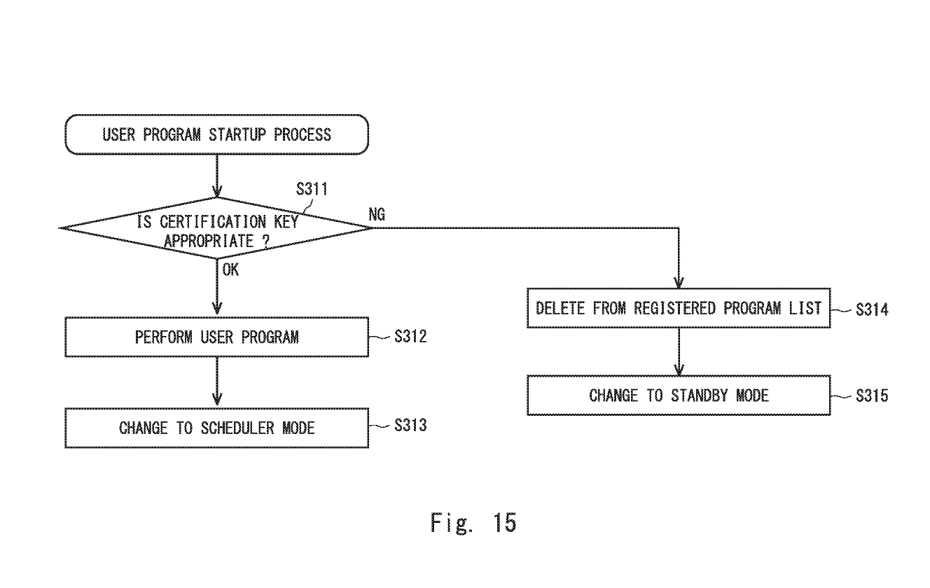

In parallel with this, the task manager 114 refers to the execution definition information 1110 and thereby determines whether or not the current time is registered as a start time (S13). Specifically, since only a start time is registered in the registered program list as described above, the task manager 114 determines whether or not the current time is “00 minute 00 second” of an arbitrarily-determined time of day by using the built-in timer and determines whether or not the correspond time is present in the registered program list. When the current time is a start time, the task manager 114 performs a process for starting up a user program P3 corresponding to the current time (S14). Specifically, the task manager 114 performs the below-described process shown in FIG. 15.

FIG. 15 is a flowchart showing a user program start-up process according to the first embodiment. Firstly, the task manager 114 determines whether or not an authentication key recorded in association with the corresponding time in the registered program list is appropriate (S311). For example, the sensor apparatus 11 determines whether or not the authentication key is appropriate by comparing the combination of the corresponding start time and the authentication key in the registered program list with a combination of a start time and an authentication key in the user program. When the authentication key is inappropriate, the task manager 114 deletes the execution address recorded in association with the start time and the authentication key in the registered program list (S314) and changes its mode to a standby mode (S315). Note that in the step S317, the sensor apparatus 11 stops the supply of electric power to each internal device and the MCU 100 changes its mode to a standby mode in which the standby power consumption is suppressed. When it becomes a specified time after the transition to the standby mode, the sensor apparatus 11 changes its mode to the scheduler mode 65.

When the authentication key is determined to be appropriate in the step S311, the task manager 114 reads out a user program stored at an execution address recorded in association with the corresponding start time in the registered program list from the data memory 1231 and starts executing the user program (S312). After that, the sensor apparatus 11 changes its mode to the scheduler mode 65 (S313).

Based on the above-described matters, it can be said that the execution definition information includes authentication information corresponding to the execution time period of a respective one of the plurality of programs, and the control unit verifies the corresponding authentication information at the start time of the execution time period for the respective one of the plurality of programs and, when the verification result is normal, starts executing the program at the start time. In this way, even when the update program is tampered with after it is registered in the sensor apparatus, the tampering can be detected and the execution of the wrongful program can be prevented.

Note that each user program is described in an interpreter language as described above, and interpreted and executed in succession from the head of the user program by the middleware/interpreter 1164. Note that in the user program, (1) definitions of parameter information such as a measurement range and a sampling rate for the sensor element, number of measurements in one measurement operation, and an upper or lower limit value for an alarm, (2) a process for acquiring a measurement result of the sensor element; (3) a process for processing the measurement result such as a calculation of the measurement result and a comparison of the measurement result, (4) a definition of a communication format, (5) a process for generating communication data by converting the processing result based on the communication format, and (6) a process for transmitting the communication data to the management server 30, and so on are implemented. Note that the aforementioned item (1) may further include a memory area to be secured in the sensor control apparatus 10 and a designated value of a database area.

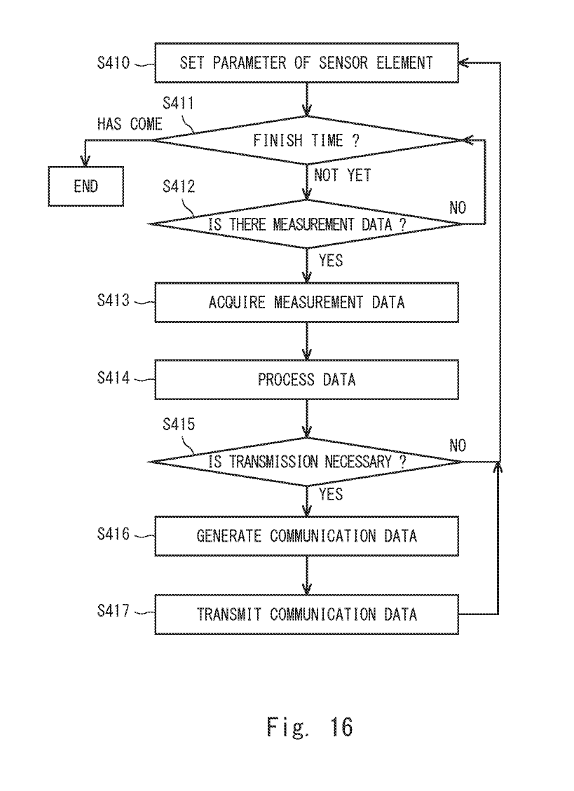

FIG. 16 is a flowchart showing processes of a user program according to the first embodiment. Firstly, the sensor apparatus 11 sets parameter information defined in the user program in the sensor element by the device driver 112 (S410). Next, the sensor apparatus 11 determines whether or not the current time has reached the end time of the user program (S411). That is, the sensor apparatus 11 acquires the current time from the timer and specifies the execution address of the time corresponding to the current time among the start times in the registered program list. Then, when the specified execution address differs from the execution address of the user program, the sensor apparatus 11 determines that the current time has reached the end time of the user program because another user program is defined in the next execution time period. In this case, the sensor apparatus 11 finishes the execution of the user program. Then, the sensor apparatus 11 changes its mode to the scheduler mode 65.

On the other hand, when the current time has not reached the end time of the user program, the sensor apparatus 11 determines whether or not there is measurement data obtained by the sensor element (S412). Here, the sensor element performs measurement with the parameter set in the step S410 and holds the measurement data in an internal memory or the like. Then, the sensor apparatus 11 checks the presence/absence of measurement data obtained by the sensor element. Note that the parameter setting includes a measurement interval. Therefore, depending on the measurement interval, there is a case where there is no measurement data in the step S412 (No at S412). In this case, after waiting a certain time, the sensor apparatus 11 performs the step S412 again. In particular, when measurement data obtained at a plurality of times are to be collectively analyzed and processed, it takes a certain time before a necessary amount of measurement data are accumulated after the step S410.

When the sensor apparatus 11 determines that a necessary amount of measurement data are accumulated in the step S412, the sensor apparatus 11 calls a driver program (device driver 112) for the sensor element, acquires the measurement data, and stored it in the storage area (S413).

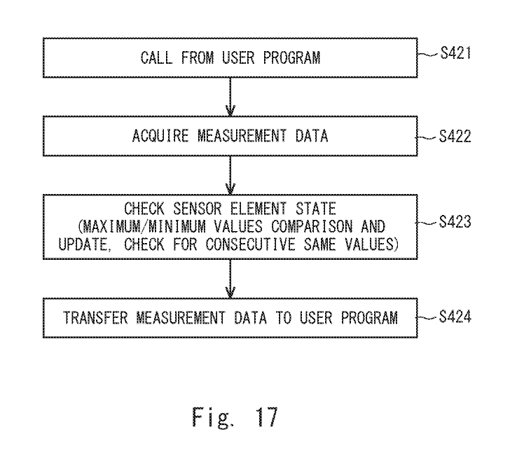

FIG. 17 is a flowchart showing processes of a deriver program for the sensor element according to the first embodiment. Firstly, the sensor apparatus 11 starts up the driver program in response to a call from the user program (S421). Then, the sensor apparatus 11 acquires measurement data from the sensor element by the driver program (S422). Next, the sensor apparatus 11 checks the state of the sensor element by the driver program (S423). For example, the sensor apparatus 11 performs a process for comparing the maximum value and minimum value of the acquired measurement data, a process for checking whether or not there are the same values in a row, and so on by the driver program. Then, when an abnormality is detected by the driver program, the sensor apparatus 11 transmits information indicating that the abnormality is detected by designating the management server 30 as the destination address and thereby notifies the management company of the information. On the other hand, when the sensor apparatus 11 confirms that the sensor element is in a normal state in the step S423, the sensor apparatus 11 transfers the measurement data to the user program that has called the driver program by the driver program (S424).

The explanation is continued by referring to FIG. 16 again. The sensor apparatus 11 performs a predetermined process for processing the acquired measurement data (S414). Examples of a predetermined processing process include a numerical calculation, a frequency conversion, peak detection, a comparison process, and so on. Then, the sensor apparatus 11 determines whether or not transmission is necessary based on the result of the processing process (S415). When transmission is necessary, the sensor apparatus 11 generates communication data by converting the processing result based on the communication format defined in the user program (S416). Then, the sensor apparatus 11 transmits the generated communication data to the management server 30 (S417). After the step S417 or when transmission is unnecessary in the step S415, the sensor apparatus 11 returns to the step S410.

As described above, in this embodiment, among user programs that could be executed in the same time period in one sensor apparatus, only one user program is selected by the scheduler (e.g., by the task manager 114). Further, parameters for measurement in a time period that is allocated to a user (such as the company X1) so that the user can use the sensor element can be arbitrarily set by a user program that is created by that user and are not dependent on the setting of the other user programs. Further, since a user program that is in execution is not suspended until the current time reaches the its end time, it is possible to continue acquiring information from the sensor element and performing a communication process for a processing result during that period without being interrupted.

Here, the process for checking the state of the sensor device in the step S423 is explained in a more detailed manner. In particular, when the sensor element goes wrong, characteristic data is output from the sensor element. For example, the same values could be repeatedly or/and periodically output from the sensor element. Note that, recently, many sensor elements output digital values. However, analog signals are output (i.e., used) inside the sensor elements. Therefore, digital values output from a sensor element are merely obtained by converting analog signals into digital signals. Therefore, the situation where same measurement data are repeatedly and periodically output is unrealistic.

Further, one of effective methods for determining a failure in a sensor element is to monitor its maximum value and minimum value. In many cases, a situation where the maximum value exceeds the set measurement range or the minimum value falls below the set measurement range, or a situation where the measured value does not fall below the upper limit value or rises above the lower limit value may be determined to be an abnormal situation. The detection of a failure in the sensor apparatus according to this embodiment is carried out by the driver program for the interface between the sensor apparatus and the sensor element. In this way, it is possible to eliminate the effect on the operation of the user program.

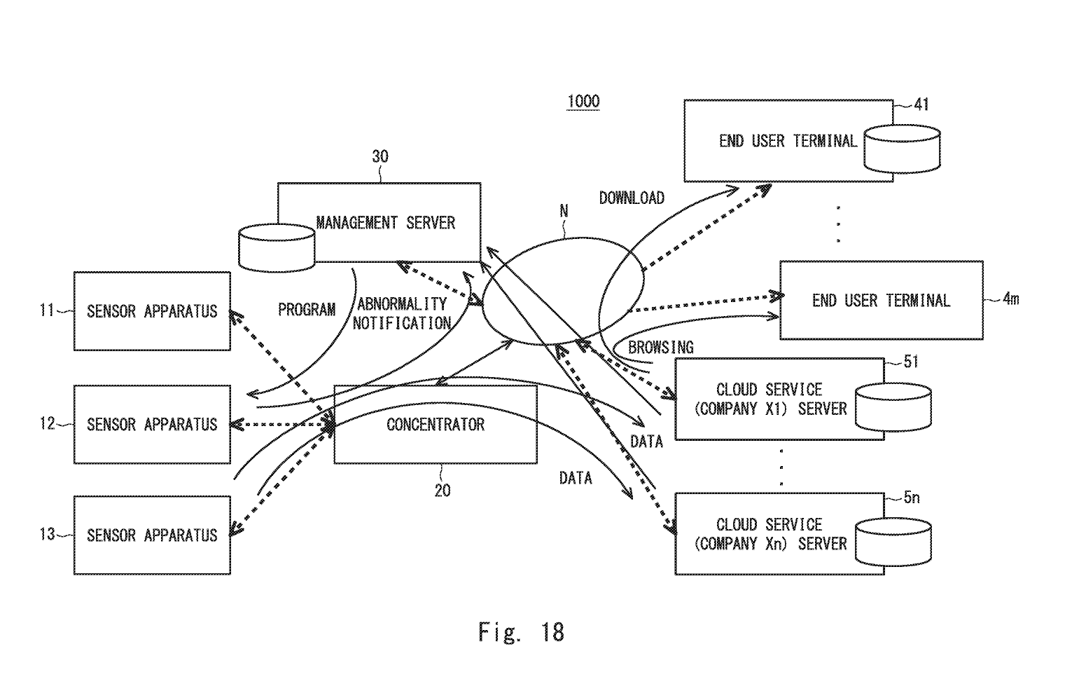

Next, the roles of the concentrator 20 and the management server 30 are explained with reference to FIG. 18. FIG. 18 is a diagram showing an outline of an information flow in the sensor system 1000 according to the first embodiment. As shown in FIG. 18, the concentrator 20 has the following three roles (or three functions):

(1-1) Transfer control of information from the management server 30 to each of the sensor apparatuses 11 to 13;
(1-2) Transfer control of information from each of the sensor apparatuses 11 to 13 to the cloud service servers 51 to 5n; and
(1-3) Transfer control of an abnormality notification from the sensor apparatuses 11 to 13 to the management server 30. Note that in each of the transfers, multi-hopping on the network N and a flow of a response message to transmission are omitted.

(1-1) In the transfer control of information to the sensor apparatuses 11 to 13, the concentrator 20 temporarily stores an instruction that is issued from the management server 30 to each sensor apparatus. Further, when the concentrator 20 receives a time inquiry request as a periodic process from each sensor apparatus, the concentrator 20 sends back the temporarily-stored instruction to the sensor apparatus that has issued the time inquiry request. Note that when the content of the transfer information to the sensor apparatus is updated before transferring the information to that sensor apparatus, the concentrator 20 discards the old information and transfers only the new information.

(1-2) In the transfer control of information (communication data) from the sensor apparatuses 11 to 13 to the cloud service servers 51 to 5n, the concentrator 20 receives communication data for which a respective sensor apparatus has processed and compressed a measurement result or the like, specifies a cloud service server at the destination by referring to a destination address specified in the communication data, and transfers the communication data to the specified cloud service server.

(1-3) In the transfer control of an abnormality notification from the sensor apparatuses 11 to 13 to the management server 30, when the concentrator 20 receives an abnormality notification of a sensor element or a sensor apparatus from the respective sensor apparatus, the concentrator 20 transfers this abnormality notification to the management server 30.

As shown in FIG. 18, the management server 30 has the following three roles (or three functions):

(2-1) To receive a user program from a cloud service company, i.e., from a user;
(2-2) To deliver a user program to the sensor apparatuses 11 to 13 through the concentrator 20; and
(2-3) To receive an abnormality notification from the sensor apparatuses 11 to 13 and notifies the management company of it.

(2-1) A user program is a program for controlling the sensor control apparatus and the sensor element. For example, the management server 30 receives a user program that is developed for the intended purpose of the company X1 from the cloud service server 51 of the company X1 through the network N. Note that the management server 30 has already delivered an authentication key corresponding to a time period in which the company X1 can exclusively use the sensor element to the company X1 in advance. Therefore, the cloud service server 51 adds the authentication key and the time period to be used (the start time or the like) in the user program to be transmitted and transmits the user program to the management server 30. The management server 30 verifies the authentication key in the start time added in the received uniform and verifies the appropriateness of the operation of the user program. Then, when the received user program is illegitimate or inappropriate, the management server 30 discards the received user program. On the other hand, when the received user program is appropriate, the management server 30 writes (i.e., records) the added combination of the start time and the authentication key in a predetermined area of the received user program.

(2-2) The management server 30 delivers the user program to the sensor apparatuses 11 to 13 through the concentrator 20. However, when the concentrator 20 is transferring communication data, an abnormality notification, or the like as the management server 30 attempts to deliver the user program, the management server 30 postpones the delivery of the user program and prioritizes the transfer process in the concentrator 20 (i.e., allows the concentrator 20 to continue the transfer process). Further, when the user program delivered to the sensor apparatuses 11 to 13 is sent back due to the echo-back, the management server 30 verifies the authentication key in the start time recorded in that user program and sends back the verification result. In this way, when the verification result is inappropriate, it is possible to delete the user program by the authentication key for which no time period is allocated from the sensor apparatus 11 and the like.

(2-3) When the management server 30 receives an abnormality notification from the sensor apparatus 11 or the like through the concentrator 20, the management server 30 delivers an email to a specific administrator of the management company or to addresses listed in a mailing list by using its own email function and thereby notifies the administrator or the like of the reception of the abnormality notification. Further, the management server 30 can enable the administrator or the like to view the content of the abnormality notification through a web browser. In this way, the management server 30 can help the administrator or the like to recognize the abnormal state.

In this way, each company that provides a cloud service can provides data browsing and downloading service to end users, who are the ultimate beneficiaries, without modifying the conventional service contents.

As described above, in this embodiment, the management server for managing the sensor apparatus is provided separately from the servers of the companies that provide cloud services and periodic processing is carried out in cooperation with the management server in the scheduler mode of the sensor apparatus. Further, functions of setting the sensor apparatus, updating a program, and eliminating illegitimate conducts, as well as a function of exclusively executing a user program are provided.

With the above-described configuration, it is possible to allow a plurality of user programs for a plurality of intended purposes to coexist and thereby to solve the above-described problem. Further, it is possible to overwrite a user program on a sensor apparatus without affecting the other user programs. Further, it is possible to conceal the algorism of the process for processing measurement data from the other users. Further, it is possible to achieve both the low cost and the low power consumption at the same time, and to acquire information in the sensor apparatus without any loss of measurement date and process the measurement data.

### Second Embodiment

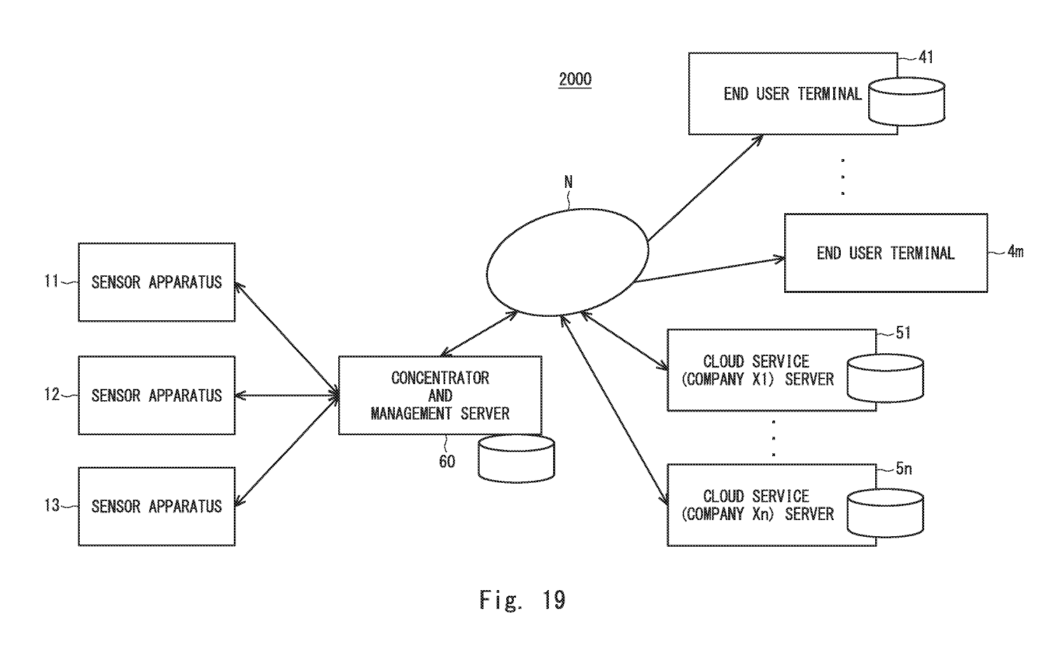

A second embodiment is a modified example of the above-described first embodiment. FIG. 19 is a block diagram showing an overall configuration of a sensor system 2000 according to the second embodiment. The sensor system 2000 corresponds to a case where the number of the concentrators 20 is only one in the above-described sensor system 1000 and the management server 30 and the only one concentrator 20 are replaced by a concentrator and management server 60. The other configuration and the operations of the sensor apparatus 11 and the like are similar to those in the first embodiment and therefore their explanations are omitted.

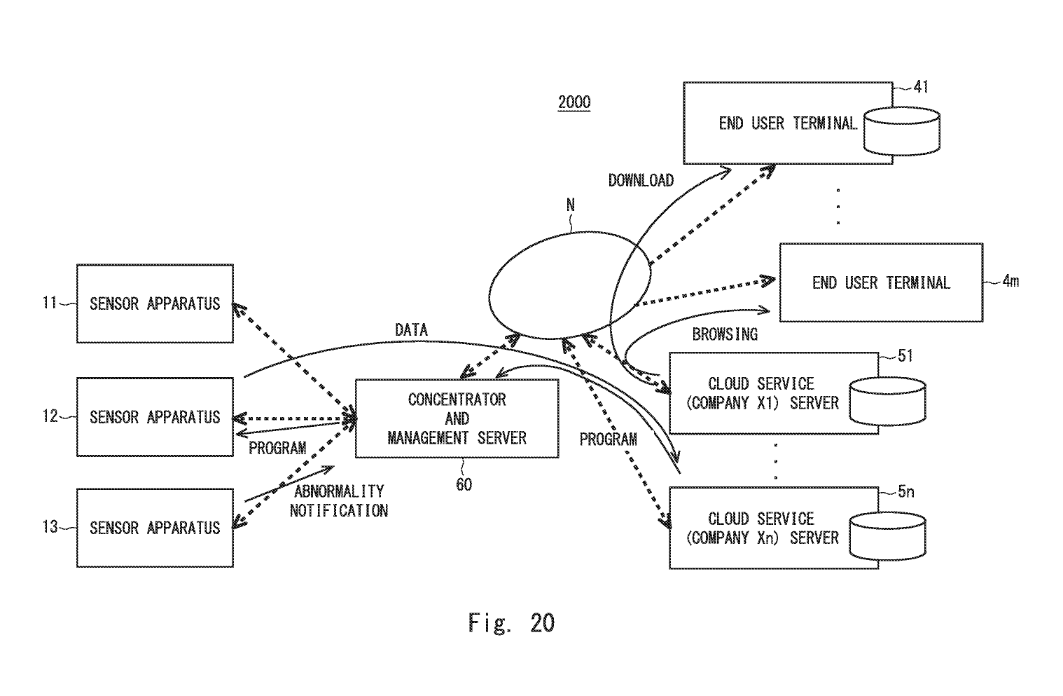

FIG. 20 is a diagram showing an outline of an information flow in the sensor system 2000 according to the second embodiment. As shown in FIG. 20, the concentrator and management server 60 has the following four roles (or four functions):

(3-1) To receive a user program from a cloud service company, i.e., from a user;
(3-2) To deliver a user program to the sensor apparatuses 11 to 13;
(3-3) To control a transfer of information from the sensor apparatuses 11 to 13 to the cloud service servers 51 to 5n; and
(3-4) To receive an abnormality notification from the sensor apparatuses 11 to 13 and notifies the management company of it. Note that similarly to the above-described first embodiment, in each of the transfers, multi-hopping on the network N and a flow of a response message to transmission are omitted.

(3-1) Similarly to the above-described item (2-1), the concentrator and management server 60 receives a user program, an authentication key, and a start time of each company from a respective one of the cloud service servers 51 to 5n of the companies, performs various verifications, and when the received user program is illegitimate or inappropriate, discards the received user program. Further, when the received user program is appropriate, the concentrator and management server 60 writes (i.e., records) the added combination of the start time and the authentication key in a predetermined area of the received user program.

(3-2) The concentrator and management server 60 directly delivers the user program to the sensor apparatuses 11 to 13 in order to collectively carry out the above-described items (2-2) and (1-1).

(3-3) Similarly to the above-described item (1-2), the concentrator and management server 60 transfers communication data to the cloud service server at the destination.

(3-4) The concentrator and management server 60 directly delivers an email to a specific administrator or to addresses listed in a mailing list in order to collectively carry out the above-described items (2-3) and (1-3).

In this way, the second embodiment provides an advantageous effect that the system operation is simplified and the costs for the installation and the operation are reduced in addition to the advantageous effect provided by the above-described first embodiment.

### Third Embodiment

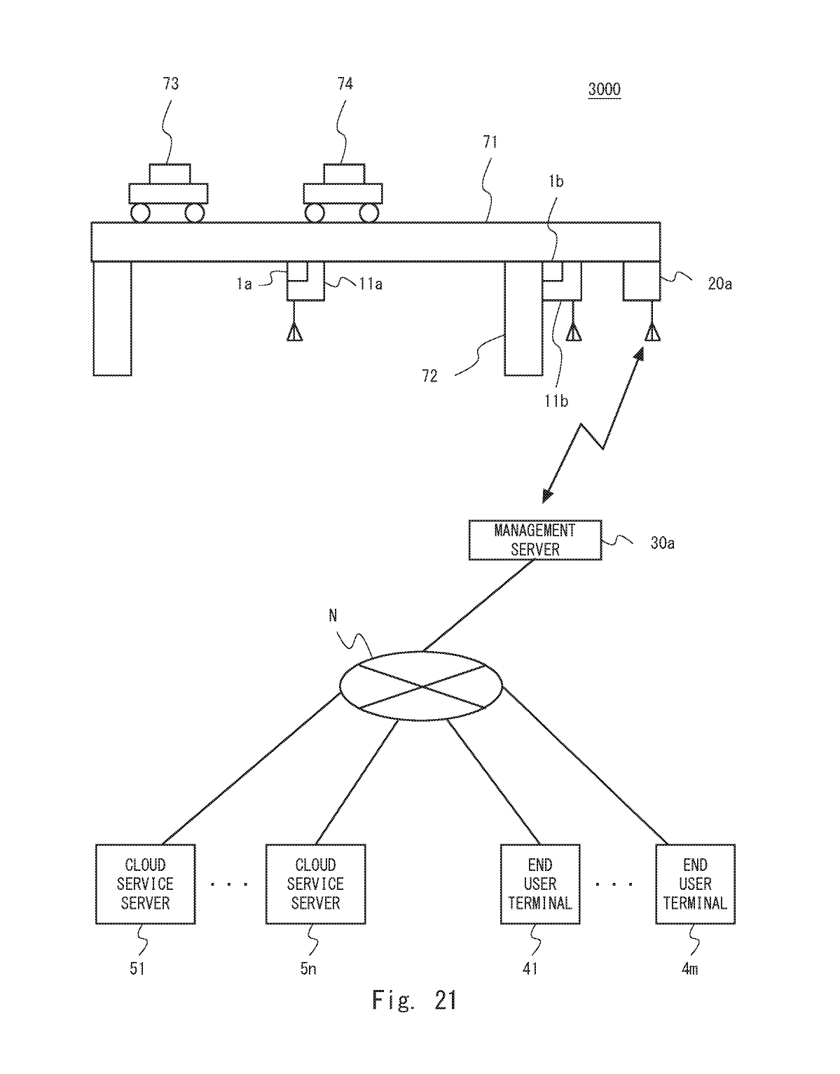

A third embodiment is an example of the above-described first or second embodiment and relates to a bridge monitoring system. FIG. 21 is a block diagram showing an overall configuration of a bridge monitoring system 3000 according to the third embodiment. The bridge monitoring system 3000 is an information system for monitoring a bridge 71, a bridge pier(s) 72, and vehicles 73 and 74 that pass through the bridge 71. The bridge monitoring system 3000 includes sensor apparatuses 11a and 11b, a concentrator 20a, and a management server 30a.

The sensor apparatuses 11a and 11b are examples of the above-described sensor apparatus 11. The sensor apparatus 11a includes at least one sensor element 1a and a sensor control apparatus connected to the sensor element 1a. Further, the sensor apparatus 11b includes at least one sensor element 1b and a sensor control apparatus connected to the sensor element 1b. Only one of the sensor apparatuses 11a and 11b may be used. Alternatively, three or more sensor apparatuses may be used. Although the sensor apparatuses 11a and 11b are disposed in the bridge 71, they may be disposed in the bridge pier 72. The sensor apparatuses 11a and 11b are examples of the above-described sensor element 11 and are provided for monitoring the bridge 71 or the bridge pier 72. Note that the place(s) where the sensor apparatuses 11a and 11b are disposed is not limited to the aforementioned places. For example, they may be disposed in a place(s) on the bridge 71 in which they do not interfere the traveling of the vehicles 73 and 74.

The concentrator 20a is an example of the above-described concentrator 20 and controls a wired or wireless data transfer between the sensor apparatuses 11a and 11b and the management server 30a through wired or wireless communication. The management server 30a is an example of the above-described management server 30, and transmits/receives data to/from the concentrator 20a and transmits/receives data to/from the cloud service servers 51 to 5n and the end user terminals 41 to 4m through the network N. Note that the concentrator 20a may be capable of communicating with the cloud service servers 51 to 5n through the network N. Alternatively, the concentrator 20a and the management server 30a are integrally formed.

The sensor apparatuses 11a and 11b have a configuration similar to each other. Therefore, the sensor apparatus 11a is explained hereinafter as an example thereof. The sensor control apparatus included in the sensor apparatus 11a includes a storage unit and a control unit. The storage unit stores a first user program provided by a first user (e.g., a company operating a cloud service server 51), a second user program provided by a second user (e.g., a company operating a cloud service server 5n), execution definition information in which different execution time periods are defined for the first and second user programs, and a periodic processing program for performing a process related to the sensor apparatus 11a. The control unit executes one of the first and second programs based on the execution definition information and periodically executes the periodic processing program.

Here, the control unit executes the first program, and thereby sets the sensor element with a first setting value, processes a measurement result obtained by the first setting value, and transmits the processing result to the server while designating the first user as its destination. Then, after finishing the execution of the first program, the control unit executes the second program, and thereby sets the sensor element with a second setting value, processes a measurement result obtained by the second setting value, and transmits the processing result to the server while designating the second user as its destination. Further, the control unit receives predetermined maintenance information from the server by the periodic processing program, which is started up during the execution of the first or second program, and performs a process based on the maintenance information.

As described above, the bridge monitoring system 3000 according to this embodiment provides advantageous effects similar to those provided by the above-described first or second embodiment.

Further, by using the third embodiment as an example, advantageous effects of the first to third embodiments are explained hereinafter in detail. In the present circumstances, sensor apparatuses including sensor elements mounted thereto are installed in order to monitor the states of bridges and bridges piers. In such cases, an acceleration sensor may be used as a sensor element. Further, it is possible to monitor changes in the eigen-frequency of the bridge by measuring vibrations that occur when a vehicle passes on the bridge by using the acceleration sensor.

Note that although the amplitude of vibrations of the bridge varies according to the weight of the vehicle, the frequency of vibrations of the bridge is determined by the structure of the bridge. That is, the eigen-frequency of the bridge is determined by the structure, in particular, by the length of the bridge. Therefore, when crevices such as cracks occur in the bridge, the structure of the bridge is changed. As a result, the measured eigen-frequency of the bridge also changes. Therefore, it is possible to detect an abnormality in the bridge by measuring the vibrations of the bridge by using a sensor element and monitoring changes in the eigen-frequency over a long term.

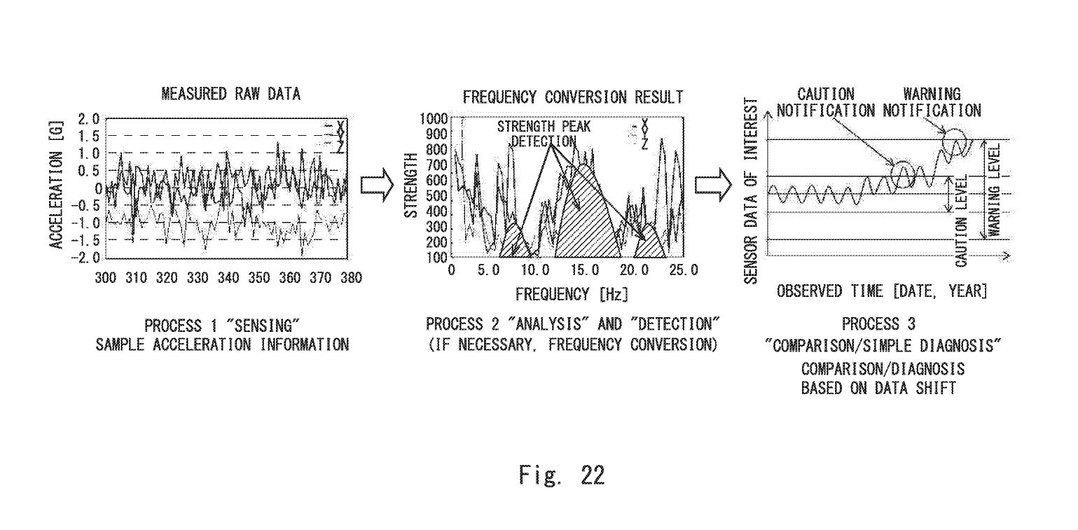

FIG. 22 is a drawing for explaining a concept of the monitoring of a bridge by using an acceleration sensor. Firstly, in sensing in a process 1, acceleration information, which is acquired by the acceleration sensor, is sampled. That is, an acceleration at each measurement time is measured by the acceleration sensor. Next, in analysis and detection in a process 2, a Fourier transform is performed on a measurement result of the process 1. Then, a relation between the frequency and the strength is derived and a peak in the strength is detected. In these processes, if necessary, a frequency conversion is performed. Then, in comparison and simple diagnosis in a process 3, data of interest of the sensor is compared with a caution level and with a warning level. That is, it is determined whether or not the peak in the strength exceeds the caution level and the warning level. When the peak exceeds the level, a warning (caution notification or warning notification) is issued.

As described above, in the present circumstances, it is possible to use a type of sensor element, i.e., an acceleration sensor for the purpose of monitoring the eigen-frequency of a bridge, i.e., monitoring the state of a bridge or a bridge pier (herein called a “health examination”).

Further, the acceleration sensor can also be used for a different purpose for the bridge. For example, the acceleration sensor can be used to acquire traffic information of vehicles that passes through the bridge. Note that in some bridges, a limitation is imposed on the weight of a vehicle that can pass through the bridge because of the tolerance (or strength) of the bridge. In such cases, it is possible to determine whether or not a vehicle that is heavier than the weight limit has passed the bridge by monitoring the amplitude of vibrations of the bridge by using the acceleration sensor. Note that it is possible to increase the probability of arresting vehicles (i.e., the drivers of vehicles) that have violated the weight limit by using, for example, photographs of license plates of such vehicles passing through the bridge together with the monitored vibrations of the bridge.

Therefore, it is conceivable to be able to use the sensor apparatus including the same sensor element (i.e., one sensor element) mounted thereto installed in the same bridge (i.e., one bridge) for both the purpose of the health examination of the bridge and acquisition of traffic information thereof.

Further, it is also possible to enable a cloud service company to provide the health examination of the bridge and traffic information thereof as big data. However, in the present circumstances, there could be such a situation that one company installs a sensor apparatus including an acceleration sensor for the purpose of the health examination of the bridge and another company installs another sensor apparatus having the same specifications for the purpose of acquiring traffic information from the same bridge. However, if a cloud service company carries out a series of operations from the installation of a sensor apparatus to the maintenance thereof on its own, the costs for these operations becomes very high, thus making the implementation of such a cloud service very difficult. Meanwhile, in many cases, each cloud service company needs to use only some of functions of the sensor apparatus and does not need to effectively use all of the functions. Accordingly, they are not necessarily able to use the sensor apparatus appropriately, thus possibly leading to an excessive investment.

Further, buyers, such as companies, governments, municipal offices, and municipalities, of information used for the health examinations of bridges differ from those of information used for acquiring traffic information of bridges.

Further, even when a sensor apparatus including the same sensor element (i.e., one sensor element) installed in the same bridge (i.e., one bridge) is used for a plurality of intended purposes, the way of setting parameters (such as a sampling rate) for the sensor element and the way of processing measured values are different from one intended purpose to another intended purpose.

Therefore, by applying the bridge monitoring system 3000 according to the third embodiment, it is possible to sell a right to exclusively use the sensor apparatus including the same sensor element installed in the same bridge for a certain time to each of cloud service companies. That is, the sensor apparatus is used in a time-sharing manner and hence it is ensured that the sensor apparatus can be exclusively used for a unit time. Therefore, it is possible to provide a mechanism for releasing (i.e., enabling) the control of the sensor element and the sensor control apparatus and the acquisition of measurement information to each of a plurality of companies on a unit-time basis. Therefore, a plurality of companies (users) can dynamically overwrite (or rewrite) their user programs for the sensor apparatus including the sensor element mounted thereto installed in an object to be measured through the management server without interfering each other, thus enabling the users to use data that they require by paying necessary prices.

Further, it is possible to create a business of a series of operations from the installation of a sensor apparatus that generates big data to providing a service. To that end, a person who carries out this embodiment can invite companies that will take part in the business, install sensor apparatuses in necessary places, and provide information to each of the companies. Then, a programing rule for using the sensor element and the sensor control apparatus is shown to each of the companies that take part in the business, and an authentication key that ensures the exclusive use in an execution time period is provided to each of the companies. Therefore, as described above, the sensor apparatus according to this embodiment enables a plurality of user programs provided by a plurality of company users to be exclusively executed and to be updated without affecting the other user programs. Then, a person who carries out this embodiment carries out maintenance (replacement of batteries, support when malfunction occurs, and so on) of the sensor apparatus while each company user can concentrate attention on its business using sensor information.

Note that for the purpose of the health examination of a bridge, the state of the bridge is monitored over a long period such as several years or several decades. Therefore, it is sufficient if measurement is carried out at least once a day. In contrast to this, for traffic information of a bridge, although it is preferable that as much information as possible can be acquired, it is still possible to provide some vacant time each day. That is, the degrees of freshness of necessary information differ from one another according to the intended purpose. Therefore, for example, for a sensor apparatus that is installed for the health examination of a bride, the sensor apparatus is available (i.e., not used) in almost all of its time periods. Accordingly, it is possible to effective use one sensor apparatus by using its vacant time for the purpose of acquiring the traffic information of the bridge.

This can be achieved by storing a user program that is implemented for the purpose of the health examination of the bridge and a user program that is implemented for the purpose of acquiring the traffic information of the bridge in the sensor apparatus according to this embodiment. In particular, for each user program, the parameter setting of the sensor element and the algorism of the processing process thereof can be implemented for each intended purpose and implemented independently of those of the other user programs. Therefore, each user can design and repair its program independently of the other users. Further, in this embodiment, as described above, even when one of the user programs is in execution in its exclusive time period in the sensor apparatus, an arbitrary one of the other user programs can be updated.

### Other Embodiments

Note that this embodiment can also solve a problem in an aspect that relates to but differs from the above-described aspect. That is, under normal circumstances, when a measurement result of a sensor element is processed, the measurement result is transferred to a server device through wired or wireless communication. Therefore, when the amount of transferred data increases, the communication load increases. In particular, when the receiving side is a microcomputer, the communication causes a bottleneck unless the speed of the receiving process is increased. However, if the speed of the receiving process is increased, the power consumption of the microcomputer increases. Therefore, it is desirable to process the measurement result on the sensor apparatus side in order to reduce the amount of transmission data.

Note that by processing a measurement result obtained by the sensor element, it can be used for various uses and purposes. However, when the measurement result is processed on the sensor apparatus side, it cannot be easily used for other purposes. Further, to begin with, there are cases in which setting values for the sensor element differ according to the intended purpose. Therefore, when one sensor element is shared among a plurality of user programs that are implemented for their respective intended purposes, it is very difficult to modify one of the user programs without affecting the other user programs. Further, to prevent or minimize the effect on the other user programs, the user needs to disclose the algorism of the user program to the other users when the user program is modified. Further, the setting values of the sensor element cannot be dynamically changed. In particular, if the setting values are dynamically changed, sensor information (measurement data) is lost at the time when the setting values are changed and hence the sensor information becomes unsatisfactorily as time-series data. To avoid this, it is necessary to install an expensive sensor element having a high-resolution analog-digital conversion processing function and sets a sampling rate and a dynamic range to values high enough to cover a plurality of intended purposes in advance at the sacrifice of the power consumption. As a result, the cost for the sensor apparatus increases.

Note that depending on the place where the sensor apparatus is installed, sufficient power supply to operate the sensor apparatus cannot be obtained. Therefore, it is necessary to devise some way of limiting the operation of the sensor apparatus (=reducing the power consumption). Note that the technique for reducing the power consumption of a sensor element has been advancing day by day. Meanwhile, regarding the power necessary for communication, it is difficult to reduce the power consumption as well as to solve the problem of the traffic in the present circumstances because there is a lot of mixed information on the standards regarding the communication distances and the frequency bands.

Therefore, in this embodiment, time periods during each of which a respective user program can exclusively use the sensor element are allocated. Further, independent setting values are set for the sensor element and a measurement result obtained with the setting values is processed in each of the user programs. However, if the time periods during which the respective user programs can exclusively use the sensor element are allocated without any intervals therebetween, it leads to a situation where one of the user programs is in execution at all times. Therefore, if some maintenance process is performed in the sensor apparatus, there is a possibility that the user program that is in execution at that moment could be affected by the maintenance process. Therefore, in this embodiment, maintenance information is received while a user program is in execution and some of maintenance processes are performed. However, maintenance processes that have a large influence are performed when no user program is in execution. In this way, it is possible to update a user program without depending on the logics of the other user programs and without affecting the operations of the other user programs. As a result, a right for using the sensor element can be sold on a unit-time basis as described previously.

Note that although the bridge and the bridge pier are used as examples of the object to be measured by the sensor element in the third embodiment, the object to be measured by the sensor element are not limited to such examples in the first and second embodiments. For example, when a sensor for monitoring (or detecting) degradation over time is already installed, the intervals between monitoring operations are long and hence the resource of the sensor are available (i.e., not used) in better part of the time period. Therefore, the sensor can be used for a business in which a vacant time is used for monitoring of other purposes.

This embodiment can be applied, for example, to infrastructure monitoring that is expected to be transformed into IoT (Internet of Things), human and animal healthcare fields, and sensor apparatuses including sensor elements mounted thereto.

Further, although the present invention is explained as a hardware configuration in the above-described embodiments, the present invention is not limited to the hardware configuration. The present invention can be implemented by implementing an arbitrary process by having a CPU (Central Processing Unit) execute a computer program.

In the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (Blue-ray (registered trademark) Disc), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The present invention made by the inventors of the present application has been explained above in a concrete manner based on embodiments. However, the present invention is not limited to the above-described embodiments, and needless to say, various modifications can be made without departing from the spirit and scope of the present invention.

The first, second and third embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A sensor control apparatus connected to at least one sensor element, comprising:
a storage unit configured to store:
a plurality of programs, in each of which a series of processes including making a predetermined setting for the sensor element, processing a measurement result based on that setting, and transmitting the processing result to an external apparatus is implemented; and
execution definition information in which mutually different execution time periods are defined for the plurality of programs; and
a control unit configured to receive predetermined maintenance information from the external apparatus and perform a process based on that maintenance information while a first program is being executed among the plurality of user programs based on the execution definition information.

2. The sensor control apparatus according to claim 1, wherein
the predetermined maintenance information includes authentication information,
when the control unit receives the predetermined maintenance information, the control unit sends back the maintenance information to the external apparatus in order to make the external apparatus verify the maintenance information, and
when a verification result of the maintenance information in the external apparatus is normal, the control unit performs the process based on the maintenance information.

3. The sensor control apparatus according to claim 1, wherein
the control unit receives an update program for a second program among the plurality of programs from the external apparatus as the maintenance information, and adds and stores that update program in the storage unit while the first program is being executed, and
the control unit starts executing the update program instead of executing the second program at an execution start time of the second program based on the execution definition information.

4. The sensor control apparatus according to claim 3, wherein
the execution definition information includes a storage destination of each program in the storage unit as an execution address, and
the control unit:
starts, at a start time of the execution time period for each of the plurality of programs, executing a program stored at the execution address corresponding to that start time;
overwrites an execution address in the second program recorded in the execution definition information with a storage destination of the update program; and
refers to, at a start time of the execution time period in the second program, the execution definition information, reads out the update program from the execution address in the second program, and starts executing the update program.

5. The sensor control apparatus according to claim 1, wherein
the control unit receives an update program for the first program from the external apparatus as the maintenance information and stores that update program in a storage destination other than that for the first program in the storage unit while the first program is being executed, and
the control unit starts, after finishing execution of the first program, executing the update program instead of executing the first program when the control unit starts the execution again based on the execution definition information.

6. The sensor control apparatus according to claim 1, wherein
the execution definition information includes authentication information corresponding to the execution time period for a respective one of the plurality of programs, and
the control unit, at a start time of the execution time period for a respective one of the plurality of programs, verifies the corresponding authentication information and starts executing the program at the start time when the verification result is normal.

7. The sensor control apparatus according to claim 1, wherein
the storage unit further stores a periodic processing program in which a process for receiving the predetermined maintenance information from the external apparatus and a process based on the maintenance information are implemented, and
the control unit starts executing one of the plurality of programs based on the execution definition information and starts executing the periodic processing program at a predetermined interval.

8. The sensor control apparatus according to claim 1, wherein
the maintenance information includes setting information for the sensor control apparatus, and
the control unit stores the received maintenance information in an area in the storage unit that is read out as initialization setting upon restart of the sensor control apparatus.

9. The sensor control apparatus according to claim 1, wherein the maintenance information includes an update program for firmware for the sensor control apparatus,
the control unit stores the received update program in an area for updating the firmware of the sensor control apparatus in the storage unit, and
the control unit updates the firmware by the update program stored in the area for the update upon restart of the sensor control apparatus.

10. The sensor control apparatus according to claim 1, wherein when the sensor element is not in operation and no transmission is being performed to the external apparatus while the first program is in execution, the control unit synchronizes its time with the time of the external apparatus.

11. A sensor system comprising a sensor control apparatus connected to at least one sensor element, and a server capable of communicating with the sensor control apparatus, wherein the sensor control apparatus comprises:
a storage unit configured to store:
a plurality of programs, in each of which a series of processes including making a predetermined setting for the sensor element, processing a measurement result based on that setting, and transmitting the processing result to the server is implemented; and
execution definition information in which mutually different execution time periods are defined for the plurality of programs; and
a control unit configured to receive predetermined maintenance information from the server and perform a process based on that maintenance information while a first program is being executed among the plurality of user programs based on the execution definition information.

12. The sensor system according to claim 11, wherein
the server holds authentication information corresponding to a respective execution time period in advance; and
the server receives an update program and the authentication information from outside and, when the authentication information is appropriate, transmits the authentication information and the update program to the sensor control apparatus as the maintenance information,
the sensor control apparatus sends backs the maintenance information to the server when the sensor control apparatus receives the maintenance information from the server,
the server verifies authentication information included in the maintenance information sent back from the sensor control apparatus and transmits a verification result to the sensor control apparatus, and
the sensor control apparatus performs a process based on the maintenance information when the verification result is normal.

13. A bridge monitoring system comprising:
a sensor apparatus including at least one sensor element mounted thereto installed for monitoring a bridge; and
a sever capable of communicating with the sensor apparatus, wherein
the sensor apparatus comprises:
a storage unit configured to store a first user program provided by a first user, a second user program provided by a second user, execution definition information in which different execution time periods are defined for the first and second user programs, and a periodic processing program for performing a process related to the sensor apparatus; and
a control unit configured to execute one of the first and second program based on the execution definition information and periodically execute the periodic processing program,
the control unit is further configured to:
execute the first program, and thereby set the sensor element with a first setting value, process a measurement result obtained by the first setting value, and transmit the processing result to the server while designating the first user as its destination,
execute, after finishing the execution of the first program, the second program, and thereby set the sensor element with a second setting value, process a measurement result obtained by the second setting value, and transmit the processing result to the server while designating the second user as its destination; and
receive predetermined maintenance information from the server by the periodic processing program, which is started up during the execution of the first or second program, and perform a process based on the maintenance information.
